(19) United States
(12) Patent Application Publication
(10) Pub. No.: US 2024/0209007 A1
(43) Pub. Date: Jun. 27, 2024

(54) STABILIZED BORON ANIONS

(71) Applicant: UNIVERSITY OF VIRGINIA PATENT FOUNDATION, Charlottesville, VA (US)

(72) Inventors: Robert Jerard GILLIARD, Jr., Charlottesville, VA (US); Kelsie E. KRANTZ, Lovingston, VA (US)

(21) Appl. No.: 18/284,962

(22) PCT Filed: Mar. 29, 2022
(86) PCT No.: PCT/US2022/022336

§ 371 Date: Sep. 29, 2023

Related U.S. Application Data
(60) Provisional application No. 63/167,245, filed on Mar. 29, 2021.

(51) Int. Cl. C07F 5/02

(52) U.S. Cl. CPC C07F 5/027

(57) ABSTRACT

Disclosed herein are anionic boron compounds. The anionic boron compounds include anionic boronic heterocycles. optionally ligated with carbenes. The anionic boron compounds are useful synthetic intermediates for boron heterocycles, as well as for sensing applications.

### CROSS-REFERENCE TO RELATED APPLICATION

This application claims the benefit of U.S. Provisional Application 63/167,245, filed Mar. 29, 2021, the contents of which are hereby incorporated in its entirety.

### FIELD OF THE INVENTION

The invention is directed to stabilized boron anions and methods of making the same. The stabilized anions are useful intermediates in the preparation of boron heterocycles, in the construction of molecular sensors, and as bulky, non-nucleophilic bases.

### BACKGROUND

Organoboranes are well-known as quintessential Lewis acids, a result of the empty p_{z} orbital at the boron center. However, with the appropriate ligand system, electron-deficient boron compounds can undergo chemical reduction; and the additional electrons transform these species into powerful nucleophiles. Boron-centered anions have become valuable synthons in organometallic chemistry, and have afforded the isolation of a wide range of unique boron-element chemical bonds (element=s-, d-, p-block element). Despite the high reactivity of these types of compounds, they can be used in situ to generate boron species that cannot be prepared using higher oxidation state starting materials. For example, anionic organoboranes have been shown to activate the C═O, H—H, Cₛₚ—H, O—O, and C—F bonds of catalytically relevant small molecules.

The incorporation of boron into polycyclic aromatic hydrocarbon (PAH) systems has gained immense attention as a creative strategy for the development of chromogenic and light-emitting materials technologies. Recently, substantial progress has been made in the synthesis of boron-based heterocycles (“borole”), and borafluorene has become a popular building block in molecular chemistry. Indeed, neutral borafluorene compounds have been used extensively as redox-flexible emissive materials and polymer-based sensors. Despite the widespread applications of borafluorene, and the profound interest in accessing novel redox chemistry, isolated examples of reduced borafluorene compounds are exceptionally rare. Understanding the chemistry of borafluorenes featuring low-valent boron centers is not only important for the advancement of redox-dependent device applications, but could also led to new materials with unique bonding or optical properties that would otherwise be inaccessible.

Monoanionic borafluorene should be attainable under specific conditions. This compound type has been desired for years, but the increased reactivity of borafluorene anions compared to their neutral counterparts makes the synthesis quite challenging. Thus, an isolable borafluorene monoanion has heretofore not been demonstrated, and the chemical reactivity of reduced BFs as a building block for boron-element-containing materials is hitherto unknown.

There remains a need for improved methods of preparing anionic boron compounds. There remains a need for improved chemical intermediates for the synthesis of boron heterocycles. There remains a need for additional non-nucleophilic base reagents.

In accordance with the purposes of the disclosed materials and methods, as embodied and broadly described herein, the disclosed subject matter, in one aspect, relates to compounds, compositions and methods of making and using compounds and compositions.

Additional advantages will be set forth in part in the description that follows, and in part will be obvious from the description, or may be learned by practice of the aspects described below. The advantages described below will be realized and attained by means of the elements and combinations particularly pointed out in the appended claims. It is to be understood that both the foregoing general description and the following detailed description are exemplary and explanatory only and are not restrictive.

The details of one or more embodiments are set forth in the descriptions below. Other features, objects, and advantages will be apparent from the description and from the claims.

### DETAILED DESCRIPTION

Before the present methods and systems are disclosed and described, it is to be understood that the methods and systems are not limited to specific synthetic methods, specific components, or to particular compositions. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes¬from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

Compounds described herein can comprise one or more asymmetric centers, and thus can exist in various stereoisomeric forms, e.g., enantiomers and/or diastereomers. For example, the compounds described herein can be in the form of an individual enantiomer, diastereomer or geometric isomer, or can be in the form of a mixture of stereoisomers, including racemic mixtures and mixtures enriched in one or more stereoisomer. Isomers can be isolated from mixtures by methods known to those skilled in the art, including chiral high pressure liquid chromatography (HPLC) and the formation and crystallization of chiral salts; or preferred isomers can be prepared by asymmetric syntheses. See, for example, Jacques et al., Enantiomers, Racemates and Resolutions, Wiley Interscience, New York, 1981; Wilen et al., Tetrahedron 33:2725 (1977); Eliel, E. L. Stereochemistry of Carbon Compounds, McGraw-Hill, NY, 1962; and Wilen, S. H., Tables of Resolving Agents and Optical Resolutions p. 268, E. L. Eliel, Ed., Univ. of Notre Dame Press, Notre Dame, IN 1972. The invention additionally encompasses compounds as individual isomers substantially free of other isomers, and alternatively, as mixtures of various isomers.

When a range of values is listed, it is intended to encompass each value and sub-range within the range. For example, “C₁₋₆ alkyl” is intended to encompass C₁, C₂, C₃, C₄, C₅, C₆, C₁₋₆, C₁₋₅, C₁₋₄, C₁₋₃, C₁₋₂, C₂₋₆, C₂₋₅, C₂₋₄, C₂₋₃, C₃₋₆, C₃₋₅, C₃₋₄, C₄₋₆, C₄₋₅, and C₅₋₆ alkyl.

The term “alkyl” refers to a radical of a straight-chain or branched hydrocarbon group having a specified range of carbon atoms (e.g., a “C₁₋₁₆ alkyl” can have from 1 to 16 carbon atoms). In some embodiments, an alkyl group has 1 to 9 carbon atoms (“C₁₋₉ alkyl”). An alkyl group can be saturated or unsaturated, i.e., an alkenyl or alkynyl group as defined herein. Unless specified to the contrary, an “alkyl” group includes both saturated alkyl groups and unsaturated alkyl groups.

In some embodiments, an alkyl group has 1 to 8 carbon atoms (“C₁₋₈ alkyl”). In some embodiments, an alkyl group has 1 to 7 carbon atoms (“C₁₋₇ alkyl”). In some embodiments, an alkyl group has 1 to 6 carbon atoms (“C₁₋₆ alkyl”). In some embodiments, an alkyl group has 1 to 5 carbon atoms (“C₁₋₅ alkyl”). In some embodiments, an alkyl group has 1 to 4 carbon atoms (“C₁₋₄ alkyl”). In some embodiments, an alkyl group has 1 to 3 carbon atoms (“C₁₋₃ alkyl”). In some embodiments, an alkyl group has 1 to 2 carbon atoms (“C₁₋₂ alkyl”). In some embodiments, an alkyl group has 1 carbon atom (“C₁ alkyl”). In some embodiments, an alkyl group has 2 to 6 carbon atoms (“C₂₋₆ alkyl”). Examples of C₁₋₆ alkyl groups include methyl (C₁), ethyl (C₂), propyl (C₃) (e.g., n-propyl, isopropyl), butyl (C₄) (e.g., n-butyl, tert-butyl, sec-butyl, iso-butyl), pentyl (C₅) (e.g., n-pentyl, 3-pentanyl, amyl, neopentyl, 3-methyl-2-butanyl, tertiary amyl), and hexyl (C₆) (e.g., n-hexyl). Additional examples of alkyl groups include n-heptyl (C₇), n-octyl (C₈), and the like. Unless otherwise specified, each instance of an alkyl group is independently unsubstituted (an “unsubstituted alkyl”) or substituted (a “substituted alkyl”) with one or more substituents (e.g., halogen, such as F). In certain embodiments, the alkyl group is an unsubstituted C₁₋₁₀ alkyl (such as unsubstituted C₁₋₆ alkyl, e.g., —CH₃ (Me), unsubstituted ethyl (Et), unsubstituted propyl (Pr, e.g., unsubstituted n-propyl (n-Pr), unsubstituted isopropyl (i-Pr)), unsubstituted butyl (Bu, e.g., unsubstituted n-butyl (n-Bu), unsubstituted tert-butyl (tert-Bu or t-Bu), unsubstituted sec-butyl (sec-Bu), unsubstituted isobutyl (i-Bu)). In certain embodiments, the alkyl group is a substituted C₁₋₁₀ alkyl (such as substituted C₁₋₆ alkyl, e.g., —CF₃, Bn).

The term “alkylenyl” refers to a divalent radical of a straight-chain, cyclic, or branched saturated hydrocarbon group having a specified range of carbon atoms (e.g., a “C₁₋₁₆ alkyl” can have from 1 to 16 carbon atoms). An example of alkylenyl is a methylene (—CH₂—). An alkylenyl can be substituted as described above for an alkyl.

The term “haloalkyl” is a substituted alkyl group, wherein one or more of the hydrogen atoms are independently replaced by a halogen, e.g., fluoro, bromo, chloro, or iodo. In some embodiments, the haloalkyl moiety has 1 to 8 carbon atoms (“C₁₋₈ haloalkyl”). In some embodiments, the haloalkyl moiety has 1 to 6 carbon atoms (“C₁₋₆ haloalkyl”). In some embodiments, the haloalkyl moiety has 1 to 4 carbon atoms (“C₁₋₄ haloalkyl”). In some embodiments, the haloalkyl moiety has 1 to 3 carbon atoms (“C₁₋₃ haloalkyl”). In some embodiments, the haloalkyl moiety has 1 to 2 carbon atoms (“C₁₋₂ haloalkyl”). Examples of haloalkyl groups include —CHF₂, —CH₂F, —CF₃, —CH₂CF₃, —CF₂CF₃, —CF₂CF₂CF₃, —CCl₃, —CFCl₂, —CF₂Cl, and the like.

The term “hydroxyalkyl” is a substituted alkyl group, wherein one or more of the hydrogen atoms are independently replaced by a hydroxyl. In some embodiments, the hydroxyalkyl moiety has 1 to 8 carbon atoms (“C₁₋₈ hydroxyalkyl”). In some embodiments, the hydroxyalkyl moiety has 1 to 6 carbon atoms (“C₁₋₆ hydroxyalkyl”). In some embodiments, the hydroxyalkyl moiety has 1 to 4 carbon atoms (“C₁₋₄ hydroxyalkyl”). In some embodiments, the hydroxyalkyl moiety has 1 to 3 carbon atoms (“C₁₋₃ hydroxyalkyl”). In some embodiments, the hydroxyalkyl moiety has 1 to 2 carbon atoms (“C₁₋₂ hydroxyalkyl”).

The term “alkoxy” refers to an alkyl group, as defined herein, appended to the parent molecular moiety through an oxygen atom. In some embodiments, the alkoxy moiety has 1 to 8 carbon atoms (“C₁₋₈ alkoxy”). In some embodiments, the alkoxy moiety has 1 to 6 carbon atoms (“C₁₋₆ alkoxy”). In some embodiments, the alkoxy moiety has 1 to 4 carbon atoms (“C₁₋₄ alkoxy”). In some embodiments, the alkoxy moiety has 1 to 3 carbon atoms (“C₁₋₃ alkoxy”). In some embodiments, the alkoxy moiety has 1 to 2 carbon atoms (“C₁₋₂ alkoxy”). Representative examples of alkoxy include, but are not limited to, methoxy, ethoxy, propoxy, 2-propoxy, butoxy and tert-butoxy.
The term “haloalkoxy” refers to a haloalkyl group, as defined herein, appended to the parent molecular moiety through an oxygen atom. In some embodiments, the alkoxy moiety has 1 to 8 carbon atoms (“C₁₋₈ haloalkoxy”). In some embodiments, the alkoxy moiety has 1 to 6 carbon atoms (“C₁₋₆ haloalkoxy”). In some embodiments, the alkoxy moiety has 1 to 4 carbon atoms (“C₁₋₄ haloalkoxy”). In some embodiments, the alkoxy moiety has 1 to 3 carbon atoms (“C₁₋₃ haloalkoxy”). In some embodiments, the alkoxy moiety has 1 to 2 carbon atoms (“C₁₋₂ haloalkoxy”). Representative examples of haloalkoxy include, but are not limited to, difluoromethoxy, trifluoromethoxy, and 2,2,2-trifluoroethoxy.

The term “alkoxyalkyl” is a substituted alkyl group, wherein one or more of the hydrogen atoms are independently replaced by an alkoxy group, as defined herein. In some embodiments, the alkoxyalkyl moiety has 1 to 8 carbon atoms (“C₁₋₈ alkoxyalkyl”). In some embodiments, the alkoxyalkyl moiety has 1 to 6 carbon atoms (“C₁₋₆ alkoxyalkyl”). In some embodiments, the alkoxyalkyl moiety has 1 to 4 carbon atoms (“C₁₋₄ alkoxyalkyl”). In some embodiments, the alkoxyalkyl moiety has 1 to 3 carbon atoms (“C₁₋₃ alkoxyalkyl”). In some embodiments, the alkoxyalkyl moiety has 1 to 2 carbon atoms (“C₁₋₂ alkoxyalkyl”).

The term “heteroalkyl” refers to an alkyl group, which further includes at least one heteroatom (e.g., 1, 2, 3, or 4 heteroatoms) selected from oxygen, nitrogen, or sulfur within (i.e., inserted between adjacent carbon atoms of) and/or placed at one or more terminal position(s) of the parent chain. In certain embodiments, a heteroalkyl group refers to a saturated group having from 1 to 20 carbon atoms and 1 or more heteroatoms within the parent chain (“heteroC₁₋₂₀ alkyl”). In some embodiments, a heteroalkyl group is a saturated group having 1 to 18 carbon atoms and 1 or more heteroatoms within the parent chain (“heteroC₁₋₁₈ alkyl”). In some embodiments, a heteroalkyl group is a saturated group having 1 to 16 carbon atoms and 1 or more heteroatoms within the parent chain (“heteroC₁₋₁₆ alkyl”). In some embodiments, a heteroalkyl group is a saturated group having 1 to 14 carbon atoms and 1 or more heteroatoms within the parent chain (“heteroC₁₋₁₄ alkyl”). In some embodiments, a heteroalkyl group is a saturated group having 1 to 12 carbon atoms and 1 or more heteroatoms within the parent chain (“heteroC₁₋₁₂ alkyl”). In some embodiments, a heteroalkyl group is a saturated group having 1 to 10 carbon atoms and 1 or more heteroatoms within the parent chain (“heteroC₁₋₁₀ alkyl”). In some embodiments, a heteroalkyl group is a saturated group having 1 to 8 carbon atoms and 1 or more heteroatoms within the parent chain (“heteroC₁₋₈ alkyl”). In some embodiments, a heteroalkyl group is a saturated group having 1 to 6 carbon atoms and 1 or more heteroatoms within the parent chain (“heteroC₁₋₆ alkyl”). In some embodiments, a heteroalkyl group is a saturated group having 1 to 4 carbon atoms and 1 or 2 heteroatoms within the parent chain (“heteroC₁₋₄ alkyl”). In some embodiments, a heteroalkyl group is a saturated group having 1 to 3 carbon atoms and 1 heteroatom within the parent chain (“heteroC₁₋₃ alkyl”). In some embodiments, a heteroalkyl group is a saturated group having 1to 2 carbon atoms and I heteroatom within the parent chain (“heteroC₁₋₂ alkyl”). In some embodiments, a heteroalkyl group is a saturated group having 1 carbon atom and 1 heteroatom (“heteroC₁ alkyl”). In some embodiments, the heteroalkyl group defined herein is a partially unsaturated group having 1 or more heteroatoms within the parent chain and at least one unsaturated carbon, such as a carbonyl group. For example, a heteroalkyl group may comprise an amide or ester functionality in its parent chain such that one or more carbon atoms are unsaturated carbonyl groups. Unless otherwise specified, each instance of a heteroalkyl group is independently unsubstituted (an “unsubstituted heteroalkyl”) or substituted (a “substituted heteroalkyl”) with one or more substituents. In certain embodiments, the heteroalkyl group is an unsubstituted heteroC₁₋₂₀ alkyl. In certain embodiments, the heteroalkyl group is an unsubstituted heteroC₁₋₁₀ alkyl. In certain embodiments, the heteroalkyl group is a substituted heteroC₁₋₂₀ alkyl. In certain embodiments, the heteroalkyl group is an unsubstituted heteroC₁₋₁₀ alkyl.

The term “alkenyl” refers to a radical of a straight-chain or branched hydrocarbon group having from 2 to 10 carbon atoms and one or more carbon-carbon double bonds (e.g., 1, 2, 3, or 4 double bonds). In some embodiments, an alkenyl group has 2 to 9 carbon atoms (“C₂₋₉ alkenyl”). In some embodiments, an alkenyl group has 2 to 8 carbon atoms (“C₂₋₈ alkenyl”). In some embodiments, an alkenyl group has 2 to 7 carbon atoms (“C₂₋₇ alkenyl”). In some embodiments, an alkenyl group has 2 to 6 carbon atoms (“C₂₋₆ alkenyl”). In some embodiments, an alkenyl group has 2 to 5 carbon atoms (“C₂₋₅ alkenyl”). In some embodiments, an alkenyl group has 2 to 4 carbon atoms (“C₂₋₄ alkenyl”). In some embodiments, an alkenyl group has 2 to 3 carbon atoms (“C₂₋₃ alkenyl”). In some embodiments, an alkenyl group has 2 carbon atoms (“C₂ alkenyl”). The one or more carbon-carbon double bonds can be internal (such as in 2-butenyl) or terminal (such as in 1-butenyl). Examples of C₂₋₄ alkenyl groups include ethenyl (C₂), 1-propenyl (C₃), 2-propenyl (C₃), 1-butenyl (C₄), 2-butenyl (C₄), butadienyl (C₄), and the like. Examples of C₂₋₆ alkenyl groups include the aforementioned C₂₋₄ alkenyl groups as well as pentenyl (C₅), pentadienyl (C₅), hexenyl (C₆), and the like. Additional examples of alkenyl include heptenyl (C₇), octenyl (C₈), octatrienyl (C₈), and the like. Unless otherwise specified, each instance of an alkenyl group is independently unsubstituted (an “unsubstituted alkenyl”) or substituted (a “substituted alkenyl”) with one or more substituents. In certain embodiments, the alkenyl group is an unsubstituted C₂₋₁₀ alkenyl. In certain embodiments, the alkenyl group is a substituted C₂₋₁₀ alkenyl. In an alkenyl group, a C═C double bond for which the stereochemistry is not specified (e.g., —CH═CHCH₃ or

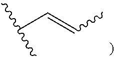

may be an (E)- or (Z)-double bond.

The term “heteroalkenyl” refers to an alkenyl group, which further includes at least one heteroatom (e.g., 1, 2, 3, or 4 heteroatoms) selected from oxygen, nitrogen, or sulfur within (i.e., inserted between adjacent carbon atoms of) and/or placed at one or more terminal position(s) of the parent chain. In certain embodiments, a heteroalkenyl group refers to a group having from 2 to 10 carbon atoms, at least one double bond, and 1 or more heteroatoms within the parent chain (“heteroC₂₋₁₀ alkenyl”). In some embodiments, a heteroalkenyl group has 2 to 9 carbon atoms at least one double bond, and 1 or more heteroatoms within the parent chain (“heteroC₂₋₉ alkenyl”). In some embodiments, a heteroalkenyl group has 2 to 8 carbon atoms, at least one double bond, and 1 or more heteroatoms within the parent chain (“heteroC₂₋₈ alkenyl”). In some embodiments, a heteroalkenyl group has 2 to 7 carbon atoms, at least one double bond, and 1 or more heteroatoms within the parent chain (“heteroC₂₋₇ alkenyl”). In some embodiments, a heteroalkenyl group has 2 to 6 carbon atoms, at least one double bond, and 1 or more heteroatoms within the parent chain (“heteroC₂₋₆ alkenyl”). In some embodiments, a heteroalkenyl group has 2 to 5 carbon atoms, at least one double bond, and 1 or 2 heteroatoms within the parent chain (“heteroC₂₋₅ alkenyl”). In some embodiments, a heteroalkenyl group has 2 to 4 carbon atoms, at least one double bond, and 1 or 2 heteroatoms within the parent chain (“heteroC₂₋₄ alkenyl”). In some embodiments, a heteroalkenyl group has 2 to 3 carbon atoms, at least one double bond, and 1 heteroatom within the parent chain (“heteroC₂₋₃ alkenyl”). In some embodiments, a heteroalkenyl group has 2 to 6 carbon atoms, at least one double bond, and 1 or 2 heteroatoms within the parent chain (“heteroC₂₋₆ alkenyl”). Unless otherwise specified, each instance of a heteroalkenyl group is independently unsubstituted (an “unsubstituted heteroalkenyl”) or substituted (a “substituted heteroalkenyl”) with one or more substituents. In certain embodiments, the heteroalkenyl group is an unsubstituted heteroC₂₋₁₀ alkenyl. In certain embodiments, the heteroalkenyl group is a substituted heteroC₂₋₁₀ alkenyl. The term “alkynyl” refers to a radical of a straight-chain or branched hydrocarbon group having from 2 to 10 carbon atoms and one or more carbon-carbon triple bonds (e.g., 1, 2, 3, or 4 triple bonds) (“C2_10 alkynyl”). In some embodiments, an alkynyl group has 2 to 9 carbon atoms (“C₂₋₉ alkynyl”). In some embodiments, an alkynyl group has 2 to 8 carbon atoms (“C₂₋₈ alkynyl”). In some embodiments, an alkynyl group has 2 to 7 carbon atoms (“C₂₋₇ alkynyl”). In some embodiments, an alkynyl group has 2 to 6 carbon atoms (“C₂₋₆ alkynyl”). In some embodiments, an alkynyl group has 2 to 5 carbon atoms (“C₂₋₅ alkynyl”). In some embodiments, an alkynyl group has 2 to 4 carbon atoms (“C₂₋₄ alkynyl”). In some embodiments, an alkynyl group has 2 to 3 carbon atoms (“C₂₋₃ alkynyl”). In some embodiments, an alkynyl group has 2 carbon atoms (“C₂ alkynyl”). The one or more carbon-carbon triple bonds can be internal (such as in 2-butynyl) or terminal (such as in 1-butynyl). Examples of C_{2_4} alkynyl groups include, without limitation, ethynyl (C₂), 1-propynyl (C₃), 2-propynyl (C₃), 1-butynyl (C₄), 2-butynyl (C₄), and the like. Examples of C₂₋₆ alkenyl groups include the aforementioned C₂₋₄ alkynyl groups as well as pentynyl (C₅), hexynyl (C₆), and the like. Additional examples of alkynyl include heptynyl (C₇), octynyl (C₈), and the like. Unless otherwise specified, each instance of an alkynyl group is independently unsubstituted (an “unsubstituted alkynyl”) or substituted (a “substituted alkynyl”) with one or more substituents. In certain embodiments, the alkynyl group is an unsubstituted C₂₋₁₀ alkynyl. In certain embodiments, the alkynyl group is a substituted C₂₋₁₀ alkynyl.

The term “heteroalkynyl” refers to an alkynyl group, which further includes at least one heteroatom (e.g., 1, 2, 3, or 4 heteroatoms) selected from oxygen, nitrogen, or sulfur within (i.e., inserted between adjacent carbon atoms of) and/or placed at one or more terminal position(s) of the parent chain. In certain embodiments, a heteroalkynyl group refers to a group having from 2 to 10 carbon atoms, at least one triple bond, and 1 or more heteroatoms within the parent chain (“heteroC₂₋₁₀ alkynyl”). In some embodiments, a heteroalkynyl group has 2 to 9 carbon atoms, at least one triple bond, and 1 or more heteroatoms within the parent chain (“heteroC₂₋₉ alkynyl”). In some embodiments, a heteroalkynyl group has 2 to 8 carbon atoms, at least one triple bond, and 1 or more heteroatoms within the parent chain (“heteroC₂₋₈ alkynyl”). In some embodiments, a heteroalkynyl group has 2 to 7 carbon atoms, at least one triple bond, and 1 or more heteroatoms within the parent chain (“heteroC₂₋₇ alkynyl”). In some embodiments, a heteroalkynyl group has 2 to 6 carbon atoms, at least one triple bond, and 1 or more heteroatoms within the parent chain (“heteroC₂₋₆ alkynyl”). In some embodiments, a heteroalkynyl group has 2 to 5 carbon atoms, at least one triple bond, and 1 or 2 heteroatoms within the parent chain (“heteroC₂₋₅ alkynyl”). In some embodiments, a heteroalkynyl group has 2 to 4 carbon atoms, at least one triple bond, and l or 2 heteroatoms within the parent chain (“heteroC₂₋₄ alkynyl”). In some embodiments, a heteroalkynyl group has 2 to 3 carbon atoms, at least one triple bond, and 1 heteroatom within the parent chain (“heteroC₂₋₃ alkynyl”). In some embodiments, a heteroalkynyl group has 2 to 6 carbon atoms, at least one triple bond, and 1 or 2 heteroatoms within the parent chain (“heteroC₂₋₆ alkynyl”). Unless otherwise specified, each instance of a heteroalkynyl group is independently unsubstituted (an “unsubstituted heteroalkynyl”) or substituted (a “substituted heteroalkynyl”) with one or more substituents. In certain embodiments, the heteroalkynyl group is an unsubstituted heteroC₂₋₁₀ alkynyl. In certain embodiments, the heteroalkynyl group is a substituted heteroC₂₋₁₀ alkynyl.

The term “carbocyclyl,” “cycloalkyl,” or “carbocyclic” refers to a radical of a non-aromatic cyclic hydrocarbon group having from 3 to 14 ring carbon atoms (“C₃₋₁₄ carbocyclyl”) and zero heteroatoms in the non-aromatic ring system. In some embodiments, a carbocyclyl group has 3 to 10 ring carbon atoms (“C₃₋₁₀ carbocyclyl”). In some embodiments, a carbocyclyl group has 3 to 8 ring carbon atoms (“C₃₋₈ carbocyclyl”). In some embodiments, a carbocyclyl group has 3 to 7 ring carbon atoms (“C₃₋₇ carbocyclyl”). In some embodiments, a carbocyclyl group has 3 to 6 ring carbon atoms (“C₃₋₆ carbocyclyl”). In some embodiments, a carbocyclyl group has 4 to 6 ring carbon atoms (“C₄₋₆ carbocyclyl”). In some embodiments, a carbocyclyl group has 5 to 6 ring carbon atoms (“C₅₋₆ carbocyclyl”). In some embodiments, a carbocyclyl group has 5 to 10 ring carbon atoms (“C₅₋₁₀ carbocyclyl”). Exemplary C₃₋₆ carbocyclyl groups include, without limitation, cyclopropyl (C₃), cyclopropenyl (C₃), cyclobutyl (C₄), cyclobutenyl (C₄), cyclopentyl (C₅), cyclopentenyl (C₅), cyclohexyl (C₆), cyclohexenyl (C₆), cyclohexadienyl (C₆), and the like.

Exemplary C₃₋₈ carbocyclyl groups include, without limitation, the aforementioned C₃₋₆ carbocyclyl groups as well as cycloheptyl (C₇), cycloheptenyl (C₇), cycloheptadienyl (C₇), cycloheptatrienyl (C₇), cyclooctyl (C₈), cyclooctenyl (C₈), bicyclo[2.2.1]heptanyl (C₇), bicyclo[2.2.2]octanyl (C₈), and the like. Exemplary C₃₋₁₀ carbocyclyl groups include, without limitation, the aforementioned C₃₋₈ carbocyclyl groups as well as cyclononyl (C₉), cyclononenyl (C₉), cyclodecyl (C₁₀), cyclodecenyl (C₁₀), octahydro-1H-indenyl (C₉), decahydronaphthalenyl (C₁₀), spiro[4.5]decanyl (C₁₀), and the like. As the foregoing examples illustrate, in certain embodiments, the carbocyclyl group is either monocyclic (“monocyclic carbocyclyl”) or polycyclic (e.g., containing a fused, bridged or spiro ring system such as a bicyclic system (“bicyclic carbocyclyl”) or tricyclic system (“tricyclic carbocyclyl”)) and can be saturated or can contain one or more carbon-carbon double or triple bonds. “Carbocyclyl” also includes ring systems wherein the carbocyclyl ring, as defined above, is fused with one or more aryl or heteroaryl groups wherein the point of attachment is on the carbocyclyl ring, and in such instances, the number of carbons continue to designate the number of carbons in the carbocyclic ring system. Unless otherwise specified, each instance of a carbocyclyl group is independently unsubstituted (an “unsubstituted carbocyclyl”) or substituted (a “substituted carbocyclyl”) with one or more substituents. In certain embodiments, the carbocyclyl group is an unsubstituted C₃₋₁₄ carbocyclyl. In certain embodiments, the carbocyclyl group is a substituted C₃₋₁₄ carbocyclyl.

In some embodiments, “carbocyclyl” is a monocyclic, saturated carbocyclyl group having from 3 to 14 ring carbon atoms (“C₃₋₁₄ cycloalkyl”). In some embodiments, a cycloalkyl group has 3 to 10 ring carbon atoms (“C₃₋₁₀ cycloalkyl”). In some embodiments, a cycloalkyl group has 3 to 8 ring carbon atoms (“C₃₋₈ cycloalkyl”). In some embodiments, a cycloalkyl group has 3 to 6 ring carbon atoms (“C₃₋₆ cycloalkyl”). In some embodiments, a cycloalkyl group has 4 to 6 ring carbon atoms (“C₄₋₆ cycloalkyl”). In some embodiments, a cycloalkyl group has 5 to 6 ring carbon atoms (“C₅₋₆ cycloalkyl”). In some embodiments, a cycloalkyl group has 5 to 10 ring carbon atoms (“C₅₋₁₀ cycloalkyl”). Examples of C₅₋₆ cycloalkyl groups include cyclopentyl (C₅) and cyclohexyl (C₆). Examples of C₃₋₆ cycloalkyl groups include the aforementioned C₅₋₆ cycloalkyl groups as well as cyclopropyl (C₃) and cyclobutyl (C₄). Examples of C₃₋₈ cycloalkyl groups include the aforementioned C₃₋₆ cycloalkyl groups as well as cycloheptyl (C₇) and cyclooctyl (C₈). Unless otherwise specified, each instance of a cycloalkyl group is independently unsubstituted (an “unsubstituted cycloalkyl”) or substituted (a “substituted cycloalkyl”) with one or more substituents. In certain embodiments, the cycloalkyl group is an unsubstituted C₃₋₁₄ cycloalkyl. In certain embodiments, the cycloalkyl group is a substituted C₃₋₁₄ cycloalkyl.

As used herein, the term “heterocyclyl” refers to an aromatic (also referred to as a heteroaryl), unsaturated, or saturated cyclic hydrocarbon that includes at least one heteroatom in the cycle. For example, the term “heterocyclyl” or “heterocyclic” refers to a radical of a 3- to 14-membered non-aromatic ring system having ring carbon atoms and 1 to 4 ring heteroatoms, wherein each heteroatom is independently selected from nitrogen, oxygen, and sulfur (“3-14 membered heterocyclyl”). In heterocyclyl groups that contain one or more nitrogen atoms, the point of attachment can be a carbon or nitrogen atom, as valency permits. A heterocyclyl group can either be monocyclic (“monocyclic heterocyclyl”) or polycyclic (e.g., a fused, bridged or spiro ring system such as a bicyclic system (“bicyclic heterocyclyl”) or tricyclic system (“tricyclic heterocyclyl”)), and can be saturated or can contain one or more carbon-carbon double or triple bonds. Heterocyclyl polycyclic ring systems can include one or more heteroatoms in one or both rings. “Heterocyclyl” also includes ring systems wherein the heterocyclyl ring, as defined above, is fused with one or more carbocyclyl groups wherein the point of attachment is either on the carbocyclyl or heterocyclyl ring, or ring systems wherein the heterocyclyl ring, as defined above, is fused with one or more aryl or heteroaryl groups, wherein the point of attachment is on the heterocyclyl ring, and in such instances, the number of ring members continue to designate the number of ring members in the heterocyclyl ring system. Unless otherwise specified, each instance of heterocyclyl is independently unsubstituted (an “unsubstituted heterocyclyl”) or substituted (a “substituted heterocyclyl”) with one or more substituents. In certain embodiments, the heterocyclyl group is an unsubstituted 3-14 membered heterocyclyl. In certain embodiments, the heterocyclyl group is a substituted 3-14 membered heterocyclyl.

In some embodiments, a heterocyclyl group is a 5-10 membered non-aromatic ring system having ring carbon atoms and 1-4 ring heteroatoms, wherein each heteroatom is independently selected from nitrogen, oxygen, and sulfur (“5-10 membered heterocyclyl”). In some embodiments, a heterocyclyl group is a 5-8 membered non-aromatic ring system having ring carbon atoms and 1-4 ring heteroatoms, wherein each heteroatom is independently selected from nitrogen, oxygen, and sulfur (“5-8 membered heterocyclyl”). In some embodiments, a heterocyclyl group is a 5-6 membered non-aromatic ring system having ring carbon atoms and 1-4 ring heteroatoms, wherein each heteroatom is independently selected from nitrogen, oxygen, and sulfur (“5-6 membered heterocyclyl”). In some embodiments, the 5-6 membered heterocyclyl has 1-3 ring heteroatoms selected from nitrogen, oxygen, and sulfur. In some embodiments, the 5-6 membered heterocyclyl has 1-2 ring heteroatoms selected from nitrogen, oxygen, and sulfur. In some embodiments, the 5-6 membered heterocyclyl has 1 ring heteroatom selected from nitrogen, oxygen, and sulfur.

Exemplary 3-membered heterocyclyl groups containing 1 heteroatom include, without limitation, aziridinyl, oxiranyl, and thiiranyl. Exemplary 4-membered heterocyclyl groups containing 1 heteroatom include, without limitation, azetidinyl, oxetanyl, and thietanyl. Exemplary 5-membered heterocyclyl groups containing 1 heteroatom include, without limitation, tetrahydrofuranyl, dihydrofuranyl, tetrahydrothiophenyl, dihydrothiophenyl, pyrrolidinyl, dihydropyrrolyl, and pyrrolyl-2,5-dione. Exemplary 5-membered heterocyclyl groups containing 2 heteroatoms include, without limitation, dioxolanyl, oxathiolanyl and dithiolanyl. Exemplary 5-membered heterocyclyl groups containing 3 heteroatoms include, without limitation, triazolinyl, oxadiazolinyl, and thiadiazolinyl. Exemplary 6-membered heterocyclyl groups containing 1 heteroatom include, without limitation, piperidinyl, tetrahydropyranyl, dihydropyridinyl, and thianyl. Exemplary 6-membered heterocyclyl groups containing 2 heteroatoms include, without limitation, piperazinyl, morpholinyl, dithianyl, and dioxanyl. Exemplary 6-membered heterocyclyl groups containing 3 heteroatoms include, without limitation, triazinyl. Exemplary 7-membered heterocyclyl groups containing 1 heteroatom include, without limitation, azepanyl, oxepanyl and thiepanyl. Exemplary 8-membered heterocyclyl groups containing 1 heteroatom include, without limitation, azocanyl, oxecanyl and thiocanyl. Exemplary bicyclic heterocyclyl groups include, without limitation, indolinyl, isoindolinyl, dihydrobenzofuranyl, dihydrobenzothienyl, tetrahydrobenzothienyl, tetrahydrobenzofuranyl, tetrahydroindolyl, tetrahydroquinolinyl, tetrahydroisoquinolinyl, decahydroquinolinyl, decahydroisoquinolinyl, octahydrochromenyl, octahydroisochromenyl, decahydronaphthyridinyl, decahydro-1,8-naphthyridinyl, octahydropyrrolo[3,2-b]pyrrole, indolinyl, phthalimidyl, naphthalimidyl, chromanyl, chromenyl, 1H-benzo[e][1,4]diazepinyl, 1,4,5,7-tetrahydropyrano[3,4-b]pyrrolyl, 5,6-dihydro-4H-furo[3,2-b]pyrrolyl, 6,7-dihydro-5H furo[3,2-b]pyranyl, 5,7-dihydro-4H-thieno[2,3-c]pyranyl, 2,3-dihydro-1H-pyrrolo[2,3-b]pyridinyl, 2,3-dihydrofuro[2,3-b]pyridinyl, 4,5,6,7-tetrahydro-1 H-pyrrolo[2,3-b]pyridinyl, 4,5,6,7-tetrahydrofuro[3,2-c]pyridinyl, 4,5,6,7-tetrahydrothieno[3,2-b]pyridinyl, 1,2,3,4-tetrahydro-1,6-naphthyridinyl, and the like.

The term “aryl” refers to a radical of a monocyclic or polycyclic (e.g., bicyclic or tricyclic) 4n+2 aromatic ring system (e.g., having 6, 10, or 14 π electrons shared in a cyclic array) having 6-14 ring carbon atoms and zero heteroatoms provided in the aromatic ring system (“C₆₋₁₄ aryl”). In some embodiments, an aryl group has 6 ring carbon atoms (“C₆ aryl”; e.g., phenyl). In some embodiments, an aryl group has 10 ring carbon atoms (“C₁₀ aryl”; e.g., naphthyl such as 1-naphthyl and 2-naphthyl). In some embodiments, an aryl group has 14 ring carbon atoms (“C₁₄ aryl”; e.g., anthracyl). “Aryl” also includes ring systems wherein the aryl ring, as defined above, is fused with one or more carbocyclyl or heterocyclyl groups wherein the radical or point of attachment is on the aryl ring, and in such instances, the number of carbon atoms continue to designate the number of carbon atoms in the aryl ring system. Unless otherwise specified, each instance of an aryl group is independently unsubstituted (an “unsubstituted aryl”) or substituted (a “substituted aryl”) with one or more substituents. In certain embodiments, the aryl group is an unsubstituted C₆₋₁₄ aryl. In certain embodiments, the aryl group is a substituted C₆₋₁₄ aryl.

“Aralkyl” is a subset of “alkyl” and refers to an alkyl group substituted by an aryl group, wherein the point of attachment is on the alkyl moiety.

The term “heteroaryl” refers to a radical of a 5-14 membered monocyclic or polycyclic (e.g., bicyclic, tricyclic) 4n+2 aromatic ring system (e.g., having 6, 10, or 14 π electrons shared in a cyclic array) having ring carbon atoms and 1-4 ring heteroatoms provided in the aromatic ring system, wherein each heteroatom is independently selected from nitrogen, oxygen, and sulfur (“5-14 membered heteroaryl”). In heteroaryl groups that contain one or more nitrogen atoms, the point of attachment can be a carbon or nitrogen atom, as valency permits. Heteroaryl polycyclic ring systems can include one or more heteroatoms in one or both rings. “Heteroaryl” includes ring systems wherein the heteroaryl ring, as defined above, is fused with one or more carbocyclyl or heterocyclyl groups wherein the point of attachment is on the heteroaryl ring, and in such instances, the number of ring members continue to designate the number of ring members in the heteroaryl ring system. “Heteroaryl” also includes ring systems wherein the heteroaryl ring, as defined above, is fused with one or more aryl groups wherein the point of attachment is either on the aryl or heteroaryl ring, and in such instances, the number of ring members designates the number of ring members in the fused polycyclic (aryl/heteroaryl) ring system. Polycyclic heteroaryl groups wherein one ring does not contain a heteroatom (e.g., indolyl, quinolinyl, carbazolyl, and the like) the point of attachment can be on either ring, i.e., either the ring bearing a heteroatom (e.g., 2-indolyl) or the ring that does not contain a heteroatom (e.g., 5-indolyl).

In some embodiments, a heteroaryl group is a 5-10 membered aromatic ring system having ring carbon atoms and 1-4 ring heteroatoms provided in the aromatic ring system, wherein each heteroatom is independently selected from nitrogen, oxygen, and sulfur (“5-10 membered heteroaryl”). In some embodiments, a heteroaryl group is a 5-8 membered aromatic ring system having ring carbon atoms and 1-4 ring heteroatoms provided in the aromatic ring system, wherein each heteroatom is independently selected from nitrogen, oxygen, and sulfur (“5-8 membered heteroaryl”). In some embodiments, a heteroaryl group is a 5-6 membered aromatic ring system having ring carbon atoms and 1-4 ring heteroatoms provided in the aromatic ring system, wherein each heteroatom is independently selected from nitrogen, oxygen, and sulfur (“5-6 membered heteroaryl”). In some embodiments, the 5-6 membered heteroaryl has 1-3 ring heteroatoms selected from nitrogen, oxygen, and sulfur. In some embodiments, the 5-6 membered heteroaryl has 1-2 ring heteroatoms selected from nitrogen, oxygen, and sulfur. In some embodiments, the 5-6 membered heteroaryl has 1 ring heteroatom selected from nitrogen, oxygen, and sulfur. Unless otherwise specified, each instance of a heteroaryl group is independently unsubstituted (an “unsubstituted heteroaryl”) or substituted (a “substituted heteroaryl”) with one or more substituents. In certain embodiments, the heteroaryl group is an unsubstituted 5-14 membered heteroaryl. In certain embodiments, the heteroaryl group is a substituted 5-14 membered heteroaryl.

Exemplary 5-membered heteroaryl groups containing 1 heteroatom include, without limitation, pyrrolyl, furanyl, and thiophenyl. Exemplary 5-membered heteroaryl groups containing 2 heteroatoms include, without limitation, imidazolyl, pyrazolyl, oxazolyl, isoxazolyl, thiazolyl, and isothiazolyl. Exemplary 5-membered heteroaryl groups containing 3 heteroatoms include, without limitation, triazolyl, oxadiazolyl, and thiadiazolyl. Exemplary 5-membered heteroaryl groups containing 4 heteroatoms include, without limitation, tetrazolyl. Exemplary 6-membered heteroaryl groups containing 1 heteroatom include, without limitation, pyridinyl. Exemplary 6-membered heteroaryl groups containing 2 heteroatoms include, without limitation, pyridazinyl, pyrimidinyl, and pyrazinyl. Exemplary 6-membered heteroaryl groups containing 3 or 4 heteroatoms include, without limitation, triazinyl and tetrazinyl, respectively. Exemplary 7-membered heteroaryl groups containing 1 heteroatom include, without limitation, azepinyl, oxepinyl, and thiepinyl. Exemplary 5,6-bicyclic heteroaryl groups include, without limitation, indolyl, isoindolyl, indazolyl, benzotriazolyl, benzothiophenyl, isobenzothiophenyl, benzofuranyl, benzoisofuranyl, benzimidazolyl, benzoxazolyl, benzisoxazolyl, benzoxadiazolyl, benzthiazolyl, benzisothiazolyl, benzthiadiazolyl, indolizinyl, and purinyl. Exemplary 6,6-bicyclic heteroaryl groups include, without limitation, naphthyridinyl, pteridinyl, quinolinyl, isoquinolinyl, cinnolinyl, quinoxalinyl, phthalazinyl, and quinazolinyl. Exemplary tricyclic heteroaryl groups include, without limitation, phenanthridinyl, dibenzofuranyl, carbazolyl, acridinyl, phenothiazinyl, phenoxazinyl, and phenazinyl.

“Heteroaralkyl” is a subset of “alkyl” and refers to an alkyl group substituted by a heteroaryl group, wherein the point of attachment is on the alkyl moiety.

Affixing the suffix “-ene” to a group indicates the group is a divalent moiety, e.g., alkylene is the divalent moiety of alkyl, alkenylene is the divalent moiety of alkenyl, alkynylene is the divalent moiety of alkynyl, heteroalkylene is the divalent moiety of heteroalkyl, heteroalkenylene is the divalent moiety of heteroalkenyl, heteroalkynylene is the divalent moiety of heteroalkynyl, carbocyclylene is the divalent moiety of carbocyclyl, heterocyclylene is the divalent moiety of heterocyclyl, arylene is the divalent moiety of aryl, and heteroarylene is the divalent moiety of heteroaryl.

A group is optionally substituted unless expressly provided otherwise. The term “optionally substituted” refers to being substituted or unsubstituted. In certain embodiments, alkyl, alkenyl, alkynyl, heteroalkyl, heteroalkenyl, heteroalkynyl, carbocyclyl, heterocyclyl, aryl, and heteroaryl groups are optionally substituted. “Optionally substituted” refers to a group which may be substituted or unsubstituted (e.g., “substituted” or “unsubstituted” alkyl, “substituted” or “unsubstituted” alkenyl, “substituted” or “unsubstituted” alkynyl, “substituted” or “unsubstituted” heteroalkyl, “substituted” or “unsubstituted” heteroalkenyl, “substituted” or “unsubstituted” heteroalkynyl, “substituted” or “unsubstituted” carbocyclyl, “substituted” or “unsubstituted” heterocyclyl, “substituted” or “unsubstituted” aryl or “substituted” or “unsubstituted” heteroaryl group). In general, the term “substituted” means that at least one hydrogen present on a group is replaced with a permissible substituent, e.g., a substituent which upon substitution results in a stable compound, e.g., a compound which does not spontaneously undergo transformation such as by rearrangement, cyclization, elimination, or other reaction. Unless otherwise indicated, a “substituted” group has a substituent at one or more substitutable positions of the group, and when more than one position in any given structure is substituted, the substituent is either the same or different at each position. The term “substituted” is contemplated to include substitution with all permissible substituents of organic compounds and includes any of the substituents described herein that results in the formation of a stable compound. The present invention contemplates any and all such combinations in order to arrive at a stable compound. For purposes of this invention, heteroatoms such as nitrogen may have hydrogen substituents and/or any suitable substituent as described herein which satisfy the valencies of the heteroatoms and results in the formation of a stable moiety. The invention is not intended to be limited in any manner by the exemplary substituents described herein.

Exemplary carbon atom substituents include, but are not limited to, halogen, —CN, —NO₂, —N₃, —SO₂H, —SO₃H, —OH, —OR^{aa}, —ON(R^{bb})₂, —N(R^{bb})₂, —N(R^{bb})₃⁺X⁻, —N(OR^{cc})R^{bb}, —SH, —SR^{aa}, —SSR^{cc}, —C(═O)R^{aa}, —CO₂H, —CHO, —C(OR^{cc})₃, —CO₂R^{aa}, —OC(═O)R^{aa}, —OCO₂R^{aa}, —C(═O)N(R^{bb})₂, —OC(═O)N(R^{bb})₂, —NR^{bb}C(═O)R^{aa}, —NR^{bb}CO₂R^{aa}, —NR^{bb}C(═O)N(R^{bb})₂, —C(═NR^{bb})R^{aa}, —C(═NR^{bb})OR^{aa}, —OC(═NR^{bb})R^{aa}, —OC(═NR^{bb})OR^{aa}, —C(═NR^{bb})N(R^{bb})₂, —OC(═NR^{bb})N(R^{bb})₂, —NR^{bb}C(═NR^{bb})N(R^{bb})₂, —C(═O)NR^{bb}SO₂R^{aa}, —NR^{bb}SO₂R^{aa}, —SO₂N(R^{bb})₂, —SO₂R^{aa}, —SO₂OR^{aa}, —OSO₂R^{aa}, —S(═O)R^{aa}, —OS(═O)R^{aa}, —Si(R^{aa})₃, —OSi(R^{aa})₃, —C(═S)N(R^{bb})₂, —C(═O)SR^{aa}, —C(═S)SR^{aa}, —SC(═S)SR^{aa}, —SC(═O)SR^{aa}, —OC(═O)SR^{aa}, —SC(═O)OR^{aa}, —SC(═O)R^{aa}, —P(═O)(R^{aa})₂, —P(═O)(OR^{cc})₂, —OP(═O)(R^{aa})₂, —OP(═O)(OR^{cc})₂, —P(═O)(N(R^{bb})₂)₂, —OP(═O)(N(R^{bb})₂)₂, —NR^{bb}P(═O)(R^{aa})₂, —NR^{bb}P(═O)(OR^{cc})₂, —NR^{bb}P(═O)(N(R^{bb})₂)₂, —P(R^{cc})₂, —P(OR^{cc})₂, —P(R^{cc})₃⁺X⁻, —P(OR^{cc})₃⁺X⁻, —P(R^{cc})₄, —P(OR^{cc})₂, —OP(R^{cc})₂, —OP(R^{cc})₃⁺X⁻, —OP(OR^{cc})₂, —OP(OR^{cc})₃⁺X⁻, —OP(R^{cc})₄, —OP(OR^{cc})₄, —B(R^{cc})₂, —B(OR^{cc})₂, —BR^{aa}(OR^{cc}), C₁₋₁₀ alkyl, C₁₋₁₀ perhaloalkyl, C₂₋₁₀ alkenyl, C₂₋₁₀ alkynyl, heteroC₁₋₁₀ alkyl, heteroC₂₋₁₀ alkenyl, heteroC₂₋₁₀ alkynyl, C₃₋₁₀ carbocyclyl, 3-14 membered heterocyclyl, C₆₋₁₄ aryl, and 5-14 membered heteroaryl, wherein each alkyl, alkenyl, alkynyl, heteroalkyl, heteroalkenyl, heteroalkynyl, carbocyclyl, heterocyclyl, aryl, and heteroaryl is independently substituted with 0, 1, 2, 3, 4, or 5 R^{dd} groups; wherein X⁻ is a counterion; or two geminal hydrogens on a carbon atom are replaced with the group ═O, ═S, ═NN(R^{bb})₂, ═NNR^{bb}C(═O)R^{aa}, ═NNR^{bb}C(═O)OR^{aa}, ═NNR^{bb}S(═O)₂R^{aa}, ═NR^{bb} or ═NOR^{cc}; each instance of R^{aa} is, independently, selected from C₁₋₁₀ alkyl, C₁₋₁₀ perhaloalkyl, C₂₋₁₀ alkenyl, C₂₋₁₀ alkynyl, heteroC₁₋₁₀ alkyl, heteroC₂₋₁₀ alkenyl, heteroC₂₋₁₀ alkynyl, C₃₋₁₀ carbocyclyl, ₃-14 membered heterocyclyl, C₆₋₁₄ aryl, and 5-14 membered heteroaryl, or two R^{aa} groups are joined to form a 3-14 membered heterocyclyl or 5-14 membered heteroaryl ring, wherein each alkyl, alkenyl, alkynyl, heteroalkyl, heteroalkenyl, heteroalkynyl, carbocyclyl, heterocyclyl, aryl, and heteroaryl is independently substituted with 0, 1, 2, 3, 4, or 5 R^{dd} groups; each instance of R^{bb} is, independently, selected from hydrogen, —OH, —OR^{aa}, —N(R^{cc})₂, —CN, —C(═O)R^{aa}, —C(═O)N(R^{cc})₂, —CO₂R^{aa}, —SO₂R^{aa}, —C(═NR^{cc})OR^{aa}, —C(═NR^{cc})N(R^{cc})₂, —SO₂N(R)₂, —SO₂R^{cc}, —SO₂OR^{cc}, —SOR^{aa}, —C(═S)N(R^{cc})₂, —C(═O)SR^{cc}, —C(═S)SR^{cc}, —P(═O)(R^{aa})₂, —P(═O)(OR^{cc})₂, —P(═O)(N(R^{cc})₂)₂, C₁₋₁₀ alkyl, C₁₋₁₀ perhaloalkyl, C₂₋₁₀ alkenyl, C₂₋₁₀ alkynyl, heteroC₁₋₁₀ alkyl, heteroC₂₋₁₀ alkenyl, heteroC₂₋₁₀ alkynyl, C₃₋₁₀ carbocyclyl, 3-14 membered heterocyclyl, C₆₋₁₄ aryl, and 5-14 membered heteroaryl, or two R^{bb} groups are joined to form a 3-14 membered heterocyclyl or 5-14 membered heteroaryl ring, wherein each alkyl, alkenyl, alkynyl, heteroalkyl, heteroalkenyl, heteroalkynyl, carbocyclyl, heterocyclyl, aryl, and heteroaryl is independently substituted with 0, 1, 2, 3, 4, or 5 R^{dd} groups; wherein X⁻ is a counterion; each instance of R^{cc} is, independently, selected from hydrogen, C₁₋₁₀ alkyl, C₁₋₁₀ perhaloalkyl, C₂₋₁₀ alkenyl, C₂₋₁₀ alkynyl, heteroC₁₋₁₀ alkyl, heteroC₂₋₁₀ alkenyl, heteroC₂₋₁₀ alkynyl, C₃₋₁₀ carbocyclyl, 3-14 membered heterocyclyl, C₆₋₁₄ aryl, and 5-14 membered heteroaryl, or two R° ° C. groups are joined to form a 3-14 membered heterocyclyl or 5-14 membered heteroaryl ring, wherein each alkyl, alkenyl, alkynyl, heteroalkyl, heteroalkenyl, heteroalkynyl, carbocyclyl, heterocyclyl, aryl, and heteroaryl is independently substituted with 0, 1, 2, 3, 4, or 5 R^{dd} groups; each instance of R^{dd} is, independently, selected from halogen, —CN, —NO₂, —N₃, —SO₂H, —SO₃H, —OH, —OR^{ee}, —ON(R^{ff})₂, —N(R^{ff})₂, —N(R^{ff})₃⁺X⁻, —N(OR^{ee})R^{ff}, —SH, —SR^{ee}, —SSR^{ee}, —C(═O)R^{ee}, —CO₂H, —CO₂R^{ee}, —OC(═O)R^{ee}, —OCO₂R^{ee}, —C(═O)N(R^{ff})₂, —OC(═O)N(R^{ff})₂, —NR^{ff}C(═O)R^{ee}, —NR^{ff}CO₂R^{ee}, —NR^{ff}C(═O)N(R^{ff})₂, —C(═NR^{ff})OR^{ee}, —OC(═NR^{ff})R^{ee}, —OC(═NR^{ff})OR^{ee}, —C(═NR^{ff})N(R^{ff})₂, —OC(═NR^{ff})N(R^{ff})₂, —NR^{ff}C(═NR^{ff})N(R^{ff})₂, —NR^{ff}SO₂R^{ee}, —SO₂N(R^{ff})₂, —SO₂R^{ee}, —SO₂OR^{ee}, —OSO₂R^{ee}, —S(═O)R^{ee}, —Si(R^{ee})₃, —OSi(R^{ee})₃, —C(═S)N(R^{ff})₂, —C(═O)SR^{ee}, —C(═S)SR^{ee}, —SC(═S)SR^{ee}, —P(═O)(OR^{ee})₂, —P(═O)(R^{ee})₂, —OP(═O)(R^{ee})₂, —OP(═O)(OR^{ee})₂, C₁₋₆ alkyl, C₁₋₆ perhaloalkyl, C₂₋₆ alkenyl, C₂₋₆ alkynyl, heteroC₁₋₆ alkyl, heteroC₂₋₆ alkenyl, heteroC₂₋₆ alkynyl, C₃₋₁₀ carbocyclyl, 3-10 membered heterocyclyl, C₆₋₁₀ aryl, 5-10 membered heteroaryl, wherein each alkyl, alkenyl, alkynyl, heteroalkyl, heteroalkenyl, heteroalkynyl, carbocyclyl, heterocyclyl, aryl, and heteroaryl is independently substituted with 0, 1, 2, 3, 4, or 5 R^{gg} groups, or two geminal R^{dd} substituents can be joined to form ═O or ═S; wherein X⁻ is a counterion; each instance of R^{ee} is, independently, selected from C₁₋₆ alkyl, C₁₋₆ perhaloalkyl, C₂₋₆ alkenyl, C₂₋₆ alkynyl, heteroC₁₋₆ alkyl, heteroC₂₋₆ alkenyl, heteroC₂₋₆ alkynyl, C₃₋₁₀ carbocyclyl, C₆₋₁₀ aryl, 3-10 membered heterocyclyl, and 3-10 membered heteroaryl, wherein each alkyl, alkenyl, alkynyl, heteroalkyl, heteroalkenyl, heteroalkynyl, carbocyclyl, heterocyclyl, aryl, and heteroaryl is independently substituted with 0, 1, 2, 3, 4, or 5 R^{gg} groups; each instance of R^{ff} is, independently, selected from hydrogen, C₁₋₆ alkyl, C₁₋₆ perhaloalkyl, C₂₋₆ alkenyl, C₂₋₆ alkynyl, heteroC₁₋₆ alkyl, heteroC₂₋₆ alkenyl, heteroC₂₋₆ alkynyl, C₃₋₁₀ carbocyclyl, 3-10 membered heterocyclyl, C₆₋₁₀ aryl and 5-10 membered heteroaryl, or two R^{ff} groups are joined to form a 3-10 membered heterocyclyl or 5-10 membered heteroaryl ring, wherein each alkyl, alkenyl, alkynyl, heteroalkyl, heteroalkenyl, heteroalkynyl, carbocyclyl, heterocyclyl, aryl, and heteroaryl is independently substituted with 0, 1, 2, 3, 4, or 5 R^{gg} groups; and each instance of R^{gg} is, independently, halogen, —CN, —NO₂, —N₃, —SO₂H, —SO₃H, —OH, —OC₁₋₆ alkyl, —ON(C₁₋₆ alkyl)₂, —N(C₁₋₆ alkyl)₂, —N(C₁₋₆ alkyl)₃⁺X⁻, —NH(C₁₋₆ alkyl)₂⁺X⁻, —NH₂(C₁₋₆ alkyl)⁺X⁻, —NH₃⁺X⁻, —N(OC₁₋₆ alkyl)(C₁₋₆ alkyl), —N(OH)(C₁₋₆ alkyl), —NH(OH), —SH, —SC₁₋₆ alkyl, —SS(C₁₋₆ alkyl), —C(═O)(C₁₋₆ alkyl), —CO₂H, —CO₂(C₁₋₆ alkyl), —OC(═O)(C₁₋₆ alkyl), —OCO₂(C₁₋₆ alkyl), —C(═O)NH₂, —C(═O)N(C₁₋₆ alkyl)₂, —OC(═O)NH(C₁₋₆ alkyl), —NHC(═O)(C₁₋₆ alkyl), —N(C₁₋₆ alkyl)C(═O)(C₁₋₆ alkyl), —NHCO₂(C₁₋₆ alkyl), —NHC(═O)N(C₁₋₆ alkyl)₂, —NHC(═O)NH(C₁₋₆ alkyl), —NHC(═O)NH₂, —C(═NH)O(C₁₋₆ alkyl), —OC(═NH)(C₁₋₆ alkyl), —OC(═NH)OC₁₋₆ alkyl, —C(═NH)N(C₁₋₆ alkyl)₂, —C(═NH)NH(C₁₋₆ alkyl), —C(═NH)NH₂, —OC(═NH)N(C₁₋₆ alkyl)₂, —OC(═NH)NH(C₁₋₆ alkyl), —OC(═NH)NH₂, —NHC(═NH)N(C₁₋₆ alkyl)₂, —NHC(═NH)NH₂, —NHSO₂(C₁₋₆ alkyl), —SO₂N(C₁₋₆ alkyl)₂, —SO₂NH(C₁₋₆ alkyl), —SO₂NH₂, —SO₂(C₁₋₆ alkyl), —SO₂O(C₁₋₆ alkyl), —OSO₂(C₁₋₆ alkyl), —SO(C₁₋₆ alkyl), —Si(C₁₋₆ alkyl)₃, —OSi(C₁₋₆ alkyl)₃, —C(═S)N(C₁₋₆ alkyl)₂, —C(═S)NH(C₁₋₆ alkyl), —C(═S)NH₂, —C(═O)S(C₁₋₆ alkyl), —C(═S)SC₁₋₆ alkyl, —SC(═S)SC₁₋₆ alkyl, —P(═O)(OC₁₋₆ alkyl)₂, —P(═O)(C₁₋₆ alkyl)₂, —OP(═O)(C₁₋₆ alkyl)₂, —OP(═O)(OC₁₋₆ alkyl)₂, C₁₋₆ alkyl, C₁₋₆ perhaloalkyl, C₂₋₆ alkenyl, C₂₋₆ alkynyl, heteroC₁₋₆ alkyl, heteroC₂₋₆ alkenyl, heteroC₂₋₆ alkynyl, C₃₋₁₀ carbocyclyl, C₆₋₁₀ aryl, 3-10 membered heterocyclyl, 5-10 membered heteroaryl; or two geminal R^{gg} substituents can be joined to form ═O or ═S; wherein X⁻ is a counterion.

The term “halo” or “halogen” refers to fluorine (fluoro, —F), chlorine (chloro, —Cl), bromine (bromo, —Br), or iodine (iodo, —I).

The term “hydroxyl” or “hydroxy” refers to the group —OH. The term “substituted hydroxyl” or “substituted hydroxyl,” by extension, refers to a hydroxyl group wherein the oxygen atom directly attached to the parent molecule is substituted with a group other than hydrogen, and includes groups selected from —OR^{aa}, —ON(R^{bb})₂, —OC(═O)SR^{aa}, —OC(═O)R^{aa}, —OCO₂R^{aa}, —OC(═O)N(R^{bb})₂, —OC(═NR^{bb})R^{aa}, —OC(═NR^{bb})OR^{aa}, —OC(═NR^{bb})N(R^{bb})₂, —OS(═O)R^{aa}, —OSO₂R^{aa}, —OSi(R^{aa})₃, —OP(R^{cc})₂, —OP(R^{cc})₃⁺X⁻, —OP(OR^{cc})₂, —OP(OR^{cc})₃⁺X⁻, —OP(═O)(R^{aa})₂, —OP(═O)(OR^{cc})₂, and —OP(═O)(N(R^{bb})₂)₂, wherein X⁻, R^{aa}, R^{bb} and R^{cc} are as defined herein.

The term “amino” refers to the group —NH₂. The term “substituted amino,” by extension, refers to a monosubstituted amino, a disubstituted amino, or a trisubstituted amino. In certain embodiments, the “substituted amino” is a monosubstituted amino or a disubstituted amino group.

The term “monosubstituted amino” refers to an amino group wherein the nitrogen atom directly attached to the parent molecule is substituted with one hydrogen and one group other than hydrogen, and includes groups selected from —NH(R^{bb}), —NHC(═O)R^{aa}, —NHCO₂R^{aa}, —NHC(═O)N(R^{bb})₂, —NHC(═NR^{bb})N(R^{bb})₂, —NHSO₂R^{aa}, —NHP(═O)(OR^{cc})₂, and —NHP(═O)(N(R^{bb})₂)₂, wherein R^{aa}, R^{bb}, and R^{cc} are as defined herein, and wherein R^{bb} of the group —NH(R^{bb}) is not hydrogen.

The term “disubstituted amino” refers to an amino group wherein the nitrogen atom directly attached to the parent molecule is substituted with two groups other than hydrogen, and includes groups selected from —N(R^{bb})₂, —NR^{bb}C(═O)R^{aa}, —NR^{bb}CO₂R^{aa}, —NR^{bb}C(═O)N(R^{bb})₂, —NR^{bb}C(═NR^{bb})N(R^{bb})₂, —NR^{bb}SO₂R^{aa}, —NR^{bb}P(═O)(OR^{cc})₂, and —NR^{bb}P(═O)(N(R^{bb})₂)₂, wherein R^{aa}, R^{bb}, and R^{cc} are as defined herein, with the proviso that the nitrogen atom directly attached to the parent molecule is not substituted with hydrogen.

The term “trisubstituted amino” refers to an amino group wherein the nitrogen atom directly attached to the parent molecule is substituted with three groups, and includes groups selected from —N(R^{bb})₂ and —N(R^{bb})₃⁺X⁻, wherein R^{bb} and X⁻ are as defined herein. The term “sulfonyl” refers to a group selected from —SO₂N(R^{bb})₂, —SO₂R^{aa}, and SO₂OR^{aa}, wherein R^{aa} and R^{bb} are as defined herein.

The term “sulfinyl” refers to the group —S(═O)R^{aa}, wherein R^{aa} is as defined herein.

The term “acyl” refers to a group having the general formula —C(═O)R^{X1}, —C(═O)OR^{X1}, —C(═O)—O—C(═O)R^{X1}, —C(═O)SR^{X1}, —C(═O)N(R^{X1})₂, —C(═S)R^{X1}, —C(═S)N(R^{X1})₂, —C(═S)O(R^{X1}), —C(═S)S(R^{X1}), —C(═NR^{X1})R^{X1}, —C(═NR^{X1})OR^{X1}, —C(═NR^{X1})SR^{X1}, and —C(═NR^{X1})N(R^{X1})₂, wherein R^{X1} is hydrogen; halogen; substituted or unsubstituted hydroxyl; substituted or unsubstituted thiol; substituted or unsubstituted amino; substituted or unsubstituted acyl, cyclic or acyclic, substituted or unsubstituted, branched or unbranched aliphatic; cyclic or acyclic, substituted or unsubstituted, branched or unbranched heteroaliphatic; cyclic or acyclic, substituted or unsubstituted, branched or unbranched alkyl; cyclic or acyclic, substituted or unsubstituted, branched or unbranched alkenyl; substituted or unsubstituted alkynyl; substituted or unsubstituted aryl, substituted or unsubstituted heteroaryl, aliphaticoxy, heteroaliphaticoxy, alkyloxy, heteroalkyloxy, aryloxy, heteroaryloxy, aliphaticthioxy, heteroaliphaticthioxy, alkylthioxy, heteroalkylthioxy, arylthioxy, heteroarylthioxy, mono- or di-aliphaticamino, mono- or di-heteroaliphaticamino, mono- or dialkylamino, mono- or di-heteroalkylamino, mono- or di-arylamino, or mono- or diheteroarylamino; or two R^{X1} groups taken together form a 5- to 6-membered heterocyclic ring.

Exemplary acyl groups include aldehydes (—CHO), carboxylic acids (—CO₂H), ketones, acyl halides, esters, amides, imines, carbonates, carbamates, and ureas. Acyl substituents include, but are not limited to, any of the substituents described herein, that result in the formation of a stable moiety (e.g., aliphatic, alkyl, alkenyl, alkynyl, heteroaliphatic, heterocyclic, aryl, heteroaryl, acyl, oxo, imino, thiooxo, cyano, isocyano, amino, azido, nitro, hydroxyl, thiol, halo, aliphaticamino, heteroaliphaticamino, alkylamino, heteroalkylamino, arylamino, heteroarylamino, alkylaryl, arylalkyl, aliphaticoxy, heteroaliphaticoxy, alkyloxy, heteroalkyloxy, aryloxy, heteroaryloxy, aliphaticthioxy, heteroaliphaticthioxy, alkylthioxy, heteroalkylthioxy, arylthioxy, heteroarylthioxy, acyloxy, and the like, each of which may or may not be further substituted).

The term “carbonyl” refers a group wherein the carbon directly attached to the parent molecule is sp² hybridized, and is substituted with an oxygen, nitrogen or sulfur atom, e.g., a group selected from ketones (e.g., —C(═O)R^{aa}), carboxylic acids (e.g., —CO₂H), aldehydes(CHO), esters (e.g., —CO₂R^{aa}, —C(═O)SR^{aa}, —C(═S)SR^{aa}), amides (e.g., —C(═O)N(R^{bb})₂, C(═O)NR^{bb}SO₂R^{aa}, —C(═S)N(R^{bb})₂, and imines (e.g., —C(═NR^{bb})R^{aa}, —C(═NR^{bb})OR^{aa}), C(═NR^{bb})N(R^{bb})₂, wherein R^{aa} and R^{bb} are as defined herein.

The term “oxo” refers to the group ═O, and the term “thiooxo” refers to the group ═S.

The term “cyano” refers to the group —CN.

The term “azide” refers to the group —N₃.

Nitrogen atoms can be substituted or unsubstituted as valency permits, and include primary, secondary, tertiary, and quaternary nitrogen atoms. Exemplary nitrogen atom substituents include, but are not limited to, hydrogen, —OH, —OR^{aa}, —N(R^{cc})₂, —CN, —C(═O)R^{aa}, —C(═O)N(R^{cc})₂, —CO₂R^{aa}, —SO₂R^{aa}, —C(═NR^{bb})R^{aa}, —C(═NR^{cc})OR^{aa}, —C(═NR)N(R^{cc})₂, —SO₂N(R^{cc})₂, —SO₂R^{cc}, —SO₂OR^{cc}, —SOR^{aa}, —C(═S)N(R^{cc})₂, —C(═O)SR^{cc}, —C(═S)SR^{cc}, —P(═O)(OR^{cc})₂, —P(═O)(R^{aa})₂, —P(═O)(N(R^{cc})₂)₂, C₁₋₁₀ alkyl, C₁₋₁₀ perhaloalkyl, C₂₋₁₀ alkenyl, C₂₋₁₀ alkynyl, heteroC₁₋₁₀ alkyl, heteroC₂₋₁₀ alkenyl, heteroC₂₋₁₀ alkynyl, C₃₋₁₀ carbocyclyl, 3-14 membered heterocyclyl, C₆₋₁₄ aryl, and 5-14 membered heteroaryl, or two R^{cc} groups attached to an N atom are joined to form a 3-14 membered heterocyclyl or a 5-14 membered heteroaryl ring, wherein each alkyl, alkenyl, alkynyl, heteroalkyl, heteroalkenyl, heteroalkynyl, carbocyclyl, heterocyclyl, aryl, and heteroaryl is independently substituted with 0, 1, 2, 3, 4, or 5 R^{dd} groups, and wherein R^{aa}, R^{bb}, R^{cc} and R^{dd} are as defined herein.

As used herein, a chemical bond depicted: [symbol] represents either a single, double, or triple bond, valency permitting. By way of example,

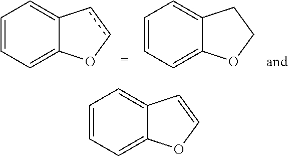

An electron-withdrawing group is a functional group or atom that pulls electron density towards itself, away from other portions of the molecule, e.g., through resonance and/or inductive effects. Exemplary electron-withdrawing groups include F, Cl, Br, I, NO₂, CN, SO₂R, SO₃R, SO₂NR₂, C(O)R^{1a}; C(O)OR, and C(O)NR₂ (wherein R is H or an alkyl, aryl, heteroaryl, cycloalkyl, heterocyclyl group) as well as alkyl group substituted with one or more of those group

An electron-donating group is a functional group or atom that pushes electron density away from itself, towards other portions of the molecule, e.g., through resonance and/or inductive effects. Exemplary electron-donating groups include unsubstituted alkyl or aryl groups, OR and N(R)₂ and alkyl groups substituted with one or more OR and N(R)₂ groups.

Unless stated to the contrary, a formula with chemical bonds shown only as solid lines and not as wedges or dashed lines contemplates each possible isomer, e.g., each enantiomer, diastereomer, and meso compound, and a mixture of isomers, such as a racemic or scalemic mixture. Unless stated to the contrary, a formula depicting one or more stereochemical features does not exclude the presence of other isomers.

Compounds disclosed herein may exist as one or more tautomers. Tautomers are interconvertible structural isomers that differ in the position of one or more protons or other labile atom. By way of example:

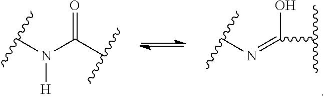

The prevalence of one tautomeric form over another will depend both on the specific chemical compound as well as its local chemical environment. Unless specified to the contrary, the depiction of one tautomeric form is inclusive of all possible tautomeric forms.

Unless stated to the contrary, a substituent drawn without explicitly specifying the point of attachment indicates that the substituent may be attached at any possible atom. For example, in a benzofuran depicted as:

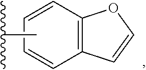

the substituent may be present at any one of the six possible carbon atoms.

As used herein, the term “null,” when referring to a possible identity of a chemical moiety, indicates that the group is absent, and the two adjacent groups are directly bonded to one another. By way of example, for a genus of compounds having the formula CH₃—X—CH₃, if X is null, then the resulting compound has the formula CH₃—CH₃.

Compounds disclosed herein may be provided in the form of salts. Examples of such salts are acid addition salts formed with inorganic acids, for example, hydrochloric, hydrobromic, sulfuric, phosphoric, and nitric acids and the like; salts formed with organic acids such as acetic, oxalic, tartaric, succinic, maleic, fumaric, gluconic, citric, malic, methanesulfonic, p-toluenesulfonic, napthalenesulfonic, and polygalacturonic acids, and the like; salts formed from elemental anions such as chloride, bromide, and iodide; salts formed from metal hydroxides, for example, sodium hydroxide, potassium hydroxide, calcium hydroxide, lithium hydroxide, and magnesium hydroxide; salts formed from metal carbonates, for example, sodium carbonate, potassium carbonate, calcium carbonate, and magnesium carbonate; salts formed from metal bicarbonates, for example, sodium bicarbonate and potassium bicarbonate; salts formed from metal sulfates, for example, sodium sulfate and potassium sulfate; and salts formed from metal nitrates, for example, sodium nitrate and potassium nitrate.

In some embodiments, the anionic boron compound includes a tri-substituted boron atom bonded to a carbene species. Such species may be depicted using either of the two resonance forms:

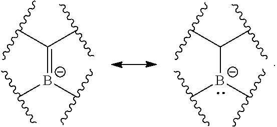

The tri-substituted and tetrasubstituted anionic boron compounds may be represented using dative bonds, e.g.:

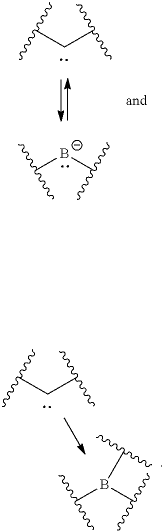

The trisubstituted anionic boron compound with two dative bonds is equivalent to the two resonance forms depicted above.

Disclosed herein are stabilized boron anions. The boron anionic compounds as defined herein can be isolated, e.g., separated from reaction solvents, reagents and by products. The stabilized boron anions can be purified by crystallization and other techniques. In some embodiments, the stabilized boron anions are in isolated form, e.g., a given sample is at least 50%, at least 60%, at least 70%, at least 75%, at least 80%, at least 85%, at least 90%, at least 95%, at least 97.5%, or at least 99% by weight. The stabilized boron compounds include a borole having the formula:

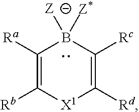

wherein
X¹ is null, O, NRⁿ, or a group having the formula:

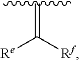

R^{a} is C₁₋₈alkyl, aryl, heteroaryl, or heterocyclyl;
R^{b} is C₁₋₈alkyl, aryl, heteroaryl, or heterocyclyl;
R^{c} is C₁₋₈alkyl, aryl, heteroaryl, or heterocyclyl;
R^{d} is C₁₋₈alkyl, aryl, heteroaryl, or heterocyclyl;
R^{e} is C₁₋₈alkyl, aryl, heteroaryl, or heterocyclyl;
R^{f} is C₁₋₈alkyl, aryl, heteroaryl, or heterocyclyl;
Rⁿ is C₁₋₈alkyl, aryl, heteroaryl, or heterocyclyl;
M⁺ is a cation providing
wherein any two or more of R^{a}, R^{b}, R^{c}, R^{d}, Rⁿ, R^{e}, and R^{f} may together form a ring.
Z is a carbene and Z* is absent, or Z and Z* together form a group having the formula:

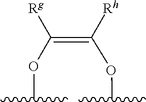

R^{g} is C₁₋₈alkyl, aryl, heteroaryl, or heterocyclyl;
R^{h} is C₁₋₈alkyl, aryl, heteroaryl, or heterocyclyl; and
wherein R^{g} and R^{h}, may together form a ring.

In order to maintain electronic balance, the compound will further include a cationic component represented by M⁺. In cases of a monoanion, a monocationic species may be present, for instance an alkali metal (Li⁺, Na⁺, K⁺, Rb⁺, or Cs⁺) or a tetraammonium species having R₄N⁺, wherein R is in each case independently selected from C₁₋₈alkyl or benzyl, wherein two or more R groups may together form a ring. In other embodiments, the cationic species may include an alkaline earth metal or a transition metal. In the case of alkaline earth metal cations and transition metal cations having an oxidation state greater than +1, the compound may have a 2:1 stoichiometry of anionic borole:M⁺ (for alkaline earth and +2 transition metals). For +3 transition metals, the compound may have a 3:1 stoichiometry. In other embodiments, the cationic species can be an alkaline earth metal cations and transition metal cations having an oxidation state greater than +1 and have a 1:1 stoichiometry with the anionic borole. In such cases, one or more spectator anions will be present, e.g., anionic borole:Mg—Cl, and the like.

The cationic component may further include a sequestration compound, for instance an ether (e.g., diethyl ether, tetrahydrofuran, tetrahydropyran, tert-butyl methyl ether, etc) crown ether, aza-crown ether, thia-crown ether, cryptand, bis-chelating ligand, tri-chelating ligand, or a combination thereof. Exemplary crown ethers include 12-crown-4, 15-crown-5, 18-crown-6, dibenzo-18-crown-6, and N,N-dimethyl aza-crown ether. Exemplary cryptands includes [1.1.1]cryptand, [2.1.1]cryptand, [2.2.1]cryptand, and [2.2.2]cryptand. Exemplary chelating ligands include bipyridines and terpyridines (e.g., 2,2-bipyridine, 3,3′-dimethoxy-2,2′-bipyridine, 4,4′-dimethoxy-2,2′-bipyridine, 9,10-phenanthroline, 2,2′:6,2″-terpyridine). Exemplary borole anions include formula:

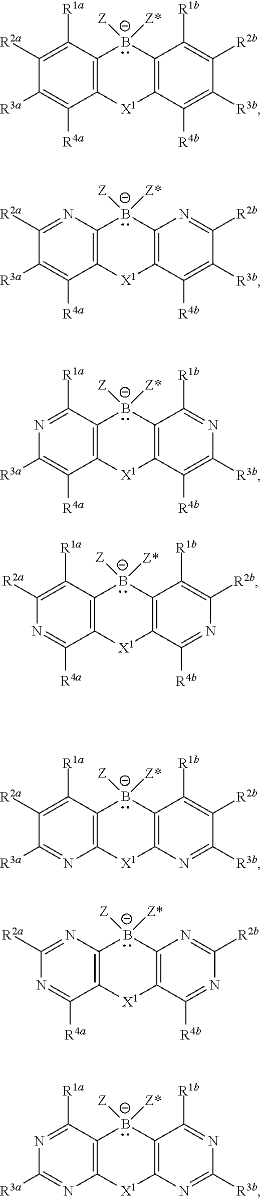

wherein
R^{1a} is H, F, Cl, Br, I, NO₂, CN, R^{1a}*, OR^{1a}*, SR^{1a}*, N(R^{1a}*)₂, SO₃R^{1a}*, SO₂R^{1a}*, SO₂N(R^{1a}*)₂, C(O)R^{1a}*; C(O)OR^{1a}*, OC(O)R^{1a}*; C(O)N(R^{1a}*)₂, N(R^{1a}*)C(O)R^{1a}*, OC(O)N(R^{1a}*)₂, N(R^{1a}*)C(O)N(R^{1a}*)₂, wherein R^{1a}* is in each case independently selected from C₁₋₈alkyl, aryl, C₁₋₈heteroaryl, C₃₋₈cycloalkyl, or C₁₋₈heterocyclyl;
R^{2a} is H, F, Cl, Br, I, NO₂, CN, R^{2a}*, OR^{2a}*, SR^{2a}*, N(R^{2a}*)₂, SO₃R^{2a}*, SO₂R^{2a}*, SO₂N(R^{2a}*)₂, C(O)R^{2a}*; C(O)OR^{2a}*, OC(O)R^{2a}*; C(O)N(R^{2a}*)₂, N(R^{2a}*)C(O)R^{2a}*, OC(O)N(R^{2a}*)₂, N(R^{2a}*)C(O)N(R^{2a}*)₂, wherein R^{2a}* is in each case independently selected from C₁₋₈alkyl, aryl, C₁₋₈heteroaryl, C₃₋₈cycloalkyl, or C₁₋₈heterocyclyl;
R^{3a} is H, F, Cl, Br, I, NO₂, CN, R^{3a}*, OR^{3a}*, SR^{3a}*, N(R^{3a}*)₂, SO₃R^{3a}*, SO₂R^{3a}*, SO₂N(R^{3a}*)₂, C(O)R^{3a}*; C(O)OR^{3a}*, OC(O)R^{3a}*; C(O)N(R^{3a}*)₂, N(R^{3a}*)C(O)R^{3a}*, OC(O)N(R^{3a}*)₂, N(R^{3a}*)C(O)N(R^{3a}*)₂, wherein R^{3a}* is in each case independently selected from C₁₋₈alkyl, aryl, C₁₋₈heteroaryl, C₃₋₈cycloalkyl, or C₁₋₈heterocyclyl;
R^{4a} is H, F, Cl, Br, I, NO₂, CN, R^{4a}*, OR^{4a}*, SR^{4a}*, N(R^{4a}*)₂, SO₃R^{4a}*, SO₂R^{4a}*, SO₂N(R^{4a}*)₂, C(O)R^{4a}*; C(O)OR^{4a}*, OC(O)R^{4a}*; C(O)N(R^{4a}*)₂, N(R^{4a}*)C(O)R^{4a}*, OC(O)N(R^{4a}*)₂, N(R^{4a}*)C(O)N(R^{4a}*)₂, wherein R^{4a}* is in each case independently selected from C₁₋₈alkyl, aryl, C₁₋₈heteroaryl, C₃₋₈cycloalkyl, or C₁₋₈heterocyclyl;
   wherein any two or more of R^{1a}, R^{2a}, R^{3a}R^{4a}, Rⁿ, and R^{e} may together form a ring,
R^{1b} is H, F, Cl, Br, I, NO₂, CN, R^{1b}*, OR^{1b}*, SR^{1b}*, N(R^{1b}*)₂, SO₃R^{1b}*, SO₂R^{1b}*, SO₂N(R^{1b}*)₂, C(O)R^{1b}*; C(O)OR^{1b}*, OC(O)R^{1b}*; C(O)N(R^{1b}*)₂, N(R^{1b}*)C(O)R^{1b}*, OC(O)N(R^{1b}*)₂, N(R^{1b}*)C(O)N(R^{1b}*)₂, wherein R^{1b}* is in each case independently selected from C₁₋₈alkyl, aryl, C₁₋₈heteroaryl, C₃₋₈cycloalkyl, or C₁₋₈heterocyclyl;
R^{2b} is H, F, Cl, Br, I, NO₂, CN, R^{2b}*, OR^{2b}*, SR^{2b}*, N(R^{2b}*)₂, SO₃R^{2b}*, SO₂R^{2b}*, SO₂N(R^{2b}*)₂, C(O)R^{2b}*; C(O)OR^{2b}*, OC(O)R^{2b}*; C(O)N(R^{2b}*)₂, N(R^{2b}*)C(O)R^{2b}*, OC(O)N(R^{2b}*)₂, N(R^{2b}*)C(O)N(R^{2b}*)₂, wherein R^{2b}* is in each case independently selected from C₁₋₈alkyl, aryl, C₁₋₈heteroaryl, C₃₋₈cycloalkyl, or C₁₋₈heterocyclyl;
R^{3b} is H, F, Cl, Br, I, NO₂, CN, R^{3b}*, OR^{3b}*, SR^{3b}*, N(R^{3b}*)₂, SO₃R^{3b}*, SO₂R^{3b}*, SO₂N(R^{3b}*)₂, C(O)R^{3b}*; C(O)OR^{3b}*, OC(O)R^{3b}*; C(O)N(R^{3b}*)₂, N(R^{3b}*)C(O)R^{3b}*, OC(O)N(R^{3b}*)₂, N(R^{3b}*)C(O)N(R^{3b}*)₂, wherein R^{3b}* is in each case independently selected from C₁₋₈alkyl, aryl, C₁₋₈heteroaryl, C₃₋₈cycloalkyl, or C₁₋₈heterocyclyl;
R^{4b} is H, F, Cl, Br, I, NO₂, CN, R^{4b}*, OR^{4b}*, SR^{4b}*, N(R^{4b}*)₂, SO₃R^{4b}*, SO₂R^{4b}*, SO₂N(R^{4b}*)₂, C(O)R^{4b}*; C(O)OR^{4b}*, OC(O)R^{4b}*; C(O)N(R^{4b}*)₂, N(R^{4b}*)C(O)R^{4b}*, OC(O)N(R^{4b}*)₂, N(R^{4b}*)C(O)N(R^{4b}*)₂, wherein R^{4b}* is in each case independently selected from C₁₋₈alkyl, aryl, C₁₋₈heteroaryl, C₃₋₈cycloalkyl, or C₁₋₈heterocyclyl;
   wherein any two or more of R^{1b}, R^{2b}, R^{3b}R^{4b}, Rⁿ, and R^{f} may together form a ring.

In certain embodiments, X¹ is null. In further sub-embodiments, X¹ is null, R^{a} and R^{b} together form an aryl ring, and R^{c} and R^{d} together form an aryl ring.

Preferred aryl rings include monobenzo, e.g.: aryl rings are mono-benzo, the borole may be represented by the formula:

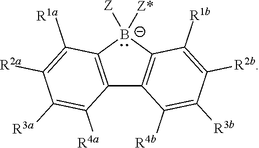

In other embodiments, X¹ is O. In further embodiments, X¹ is NRⁿ. In yet further embodiments, X¹ is:

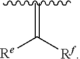

In such embodiments, R^{e} may form a polyaryl ring with R^{a} and R^{b} and/or R^{f} may form a polyaryl ring with R^{c} and R^{d}, e.g.:

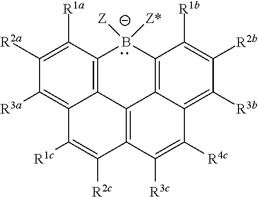

R^{1c} is H, F, Cl, Br, I, NO₂, CN, R^{1c}*, OR^{1c}*, SR^{1c}*, N(R^{1c}*)₂, SO₃R^{1c}*, SO₂R^{1c}*, SO₂N(R^{1c}*)₂, C(O)R^{1c}*; C(O)OR^{1c}*, OC(O)R^{1c}*; C(O)N(R^{1c}*)₂, N(R^{1c}*)C(O)R^{1c}*, OC(O)N(R^{1c}*)₂, N(R^{1c}*)C(O)N(R^{1c}*)₂, wherein R^{1c}* is in each case independently selected from C₁₋₈alkyl, aryl, C₁₋₈heteroaryl, C₃₋₈cycloalkyl, or C₁₋₈heterocyclyl;
R^{2c} is H, F, Cl, Br, I, NO₂, CN, R^{2c}*, OR^{2c}*, SR^{2c}*, N(R^{2c}*)₂, SO₃R^{2c}*, SO₂R^{2c}*, SO₂N(R^{2c}*)₂, C(O)R^{2c}*; C(O)OR^{2c}*, OC(O)R^{2c}*; C(O)N(R^{2c}*)₂, N(R^{2c}*)C(O)R^{2c}*, OC(O)N(R^{2c}*)₂, N(R^{2c}*)C(O)N(R^{2c}*)₂, wherein R^{2c}* is in each case independently selected from C₁₋₈alkyl, aryl, C₁₋₈heteroaryl, C₃₋₈cycloalkyl, or C₁₋₈heterocyclyl;
R^{3c} is H, F, Cl, Br, I, NO₂, CN, R^{3c}*, OR^{3c}*, SR^{3c}*, N(R^{3c}*)₂, SO₃R^{3c}*, SO₂R^{3c}*, SO₂N(R^{3c}*)₂, C(O)R^{3c}*; C(O)OR^{3c}*, OC(O)R^{3c}*; C(O)N(R^{3c}*)₂, N(R^{3c}*)C(O)R^{3c}*, OC(O)N(R^{3c}*)₂, N(R^{3c}*)C(O)N(R^{3c}*)₂, wherein R^{3c}* is in each case independently selected from C₁₋₈alkyl, aryl, C₁₋₈heteroaryl, C₃₋₈cycloalkyl, or C₁₋₈heterocyclyl;
R^{4c} is H, F, Cl, Br, I, NO₂, CN, R^{4c}*, OR^{4c}*, SR^{4c}*, N(R^{4c}*)₂, SO₃R^{4c}*, SO₂R^{4c}*, SO₂N(R^{4c}*)₂, C(O)R^{4c}*; C(O)OR^{4c}*, OC(O)R^{4c}*; C(O)N(R^{4c}*)₂, N(R^{4c}*)C(O)R^{4c}*, OC(O)N(R^{4c}*)₂, N(R^{4c}*)C(O)N(R^{4c}*)₂, wherein R^{4c}* is in each case independently selected from C₁₋₈alkyl, aryl, C₁₋₈heteroaryl, C₃₋₈cycloalkyl, or C₁₋₈heterocyclyl;
   wherein any two or more of R^{1c}, R^{2c}, R^{3c}, R^{4c}, R^{3a}, and R^{3b} may together form a ring.

In certain embodiments, the Ra, Rb, Rc, Rd, Re, and Rf (when the latter two are present) may form unsubstituted aryl or heteroaryl rings, e.g., each of R^{1a}, R^{2a}, R^{3a}, R^{4a}, R^{1b}, R^{2b}, R^{3b}, R^{4b}, R^{1c}, R^{2c}, R^{3c}, R^{4c}, etc. are either absent or hydrogen. In other embodiments, the stability and reactivity of the anionic boron compound may be tuned using one or more electron-donating or electron-withdrawing groups. For example, the aryl/heteroaryl rings may be monosubstituted:
R^{1a}, R^{2a}, and R^{3a} are each hydrogen, and R^{4a} is not hydrogen, for example selected from F, Cl, Br, I, NO₂, CN, R^{4a}*, OR^{4a}*, SR^{4a}*, N(R^{4a}*)₂, wherein R^{4a}* is in each case independently selected from C₁₋₈alkyl and aryl; exemplary non-hydrogen groups include methyl ethyl, isopropyl, methoxy, ethoxy, isopropoxy, dimethylamino, diethylamino, and diethylamino;
R^{1a}, R^{2a}, and R^{4a} are each hydrogen, and R^{3a} is not hydrogen, for example selected from F, Cl, Br, I, NO₂, CN, R^{3a}*, OR^{3a}*, SR^{3a}*, N(R^{3a}*)₂, wherein R^{3a}* is in each case independently selected from C₁₋₈alkyl and aryl; exemplary non-hydrogen groups include methyl ethyl, isopropyl, methoxy, ethoxy, isopropoxy, dimethylamino, diethylamino, and diethylamino;
R^{1a}, R^{3a}, and R^{4a} are each hydrogen, and R^{2a} is not hydrogen, for example selected from F, Cl, Br, I, NO₂, CN, R^{2a}*, OR^{2a}*, SR^{2a}*, N(R^{2a}*)₂, wherein R^{2a}* is in each case independently selected from C₁₋₈alkyl and aryl; exemplary non-hydrogen groups include methyl ethyl, isopropyl, methoxy, ethoxy, isopropoxy, dimethylamino, diethylamino, and diethylamino;
R^{2a}, R^{3a}, and R^{4a} are each hydrogen, and R^{1a} is not hydrogen, for example selected from F, Cl, Br, I, NO₂, CN, R^{1a}*, OR^{1a}*, SR^{1a}*, N(R^{1a}*)₂, wherein R^{1a}* is in each case independently selected from C₁₋₈alkyl and aryl; exemplary non-hydrogen groups include methyl ethyl, isopropyl, methoxy, ethoxy, isopropoxy, dimethylamino, diethylamino, and diethylamino;
R^{1b}, R^{2b}, and R^{3b} are each hydrogen, and R^{4b} is selected from F, Cl, Br, I, NO₂, CN, R^{4b}*, OR^{4b}*, SR^{4b}*, N(R^{4b}*)₂, wherein R^{4b}* is in each case independently selected from C₁₋₈alkyl and aryl; exemplary non-hydrogen groups include methyl ethyl, isopropyl, methoxy, ethoxy, isopropoxy, dimethylamino, diethylamino, and diethylamino;
R^{1b}, R^{2b}, and R^{4b} are each hydrogen, and R^{3b} is not hydrogen, for example selected from F, Cl, Br, I, NO₂, CN, R^{3b}*, OR^{3b}*, SR^{3b}*, N(R^{3b}*)₂, wherein R^{3b}* is in each case independently selected from C₁₋₈alkyl and aryl; exemplary non-hydrogen groups include methyl ethyl, isopropyl, methoxy, ethoxy, isopropoxy, dimethylamino, diethylamino, and diethylamino;
R^{1b}, R^{3b}, and R^{4b} are each hydrogen, and R^{2b} is not hydrogen, for example selected from F, Cl, Br, I, NO₂, CN, R^{2b}*, OR^{2b}*, SR^{2b}*, N(R^{2b}*)₂, wherein R^{2b}* is in each case independently selected from C₁₋₈alkyl and aryl; exemplary non-hydrogen groups include methyl ethyl, isopropyl, methoxy, ethoxy, isopropoxy, dimethylamino, diethylamino, and diethylamino;
R^{2b}, R^{3b}, and R^{4b} are each hydrogen, and R^{1b} is not hydrogen, for example selected from F, Cl, Br, I, NO₂, CN, R^{1b}*, OR^{1b}*, SR^{1b}*, N(R^{1b}*)₂, wherein R^{1b}* is in each case independently selected from C₁₋₈alkyl and aryl. exemplary non-hydrogen groups include methyl ethyl, isopropyl, methoxy, ethoxy, isopropoxy, dimethylamino, diethylamino, and diethylamino;
Z and Z* can together form a carbene; such ligands are well known in the art. For example, Z and Z* can together form a diaminocarbene or a heteroamino carbene. In some instances, the carbene can have the formula:

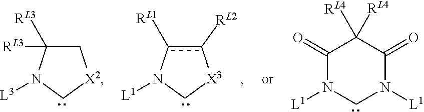

wherein
X² is C(R^{L4})₂;
X³ is N^{L2};
L¹ is C₁₋₂₀alkyl, aryl or heteroaryl,
L² is C₁₋₂₀alkyl, aryl or heteroaryl,
R^{L1} is hydrogen, C₁₋₁₂alkyl, cycloalkyl, aryl, heteroaryl;
R^{L2} is hydrogen, C₁₋₁₂alkyl, cycloalkyl, aryl, heteroaryl;
R^{L3} is in each case independently selected from C₁₋₂₀alkyl, aryl, heteroaryl; wherein two R^{L3} groups may together form a ring;
R^{L4} is in each case independently selected from C₁₋₂₀alkyl, aryl, heteroaryl; wherein two R^{L4} groups may together form a ring;
wherein L¹ and R^{L1} may together form a ring;
wherein R^{L1} and R^{L2} may together form a ring;
wherein L² and R^{L2} may together form a ring;
wherein L³ and one or both of R^{L3} may together form a ring.

Exemplary carbenes include compounds having the formula

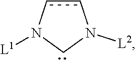

wherein L¹ is aryl and L² is selected from aryl and C₁₋₈alkyl. In some instances, L¹ can have the formula:

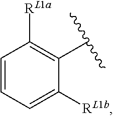

wherein R^{L1a} is H or C₁₋₄alkyl, and R^{L1b} is H or C₁₋₄alkyl. Similarly, in some instances L² has the formula:

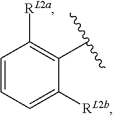

wherein R^{L2a} is H or C₁₋₄alkyl, and R^{L2b} is H or C₁₋₄alkyl. Preferably, each of R^{L1a}, R^{L1b}, R^{L2a}, and R^{L2b} are each C₁₋₄alkyl, e.g., methyl, ethyl, n-propyl, isopropyl, n-butyl, isobutyl, sec-butyl, or tert-butyl. In certain sub-embodiments, each of R^{L1a}, R^{L1b}, R^{L2a}, and R^{L2b} are isopropyl.

In other embodiments, the carbene can have the formula:

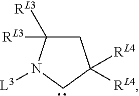

Preferably, L³ has the formula:

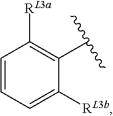

wherein R^{L3a} is H or C₁₋₄alkyl, and R^{L3b} is H or C₁₋₄alkyl.

In certain preferred sub-embodiments, R^{L3a} and R^{L3b} are each C₁₋₄alkyl, e.g., methyl, ethyl, n-propyl, isopropyl, n-butyl, isobutyl, sec-butyl, or tert-butyl. In certain sub-embodiments, each of R^{L3a} and R^{L3b} are isopropyl.

In some instances, R^{L3} is C₁₋₄alkyl, e.g., methyl, ethyl, n-propyl, isopropyl, n-butyl, isobutyl, sec-butyl, or tert-butyl.

In some instances, R^{L4} is C₁₋₄alkyl, e.g., methyl, ethyl, n-propyl, isopropyl, n-butyl, isobutyl, sec-butyl, or tert-butyl.

In further sub-embodiments, Z and Z* together form a ring having the formula:

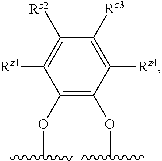

wherein
R^{z1} is H, F, Cl, Br, I, NO₂, CN, R^{z1}*, OR^{z1}*, SR^{z1}*, N(R^{z1}*)₂, SO₃R^{z1}*, SO₂R^{z1}*, SO₂N(R^{z1}*)₂, C(O)R^{z1}*; C(O)OR^{z1}*, OC(O)R^{z1}*; C(O)N(R^{z1}*)₂, N(R^{z1}*)C(O)R^{z1}*, OC(O)N(R^{z1}*)₂, N(R^{z1}*)C(O)N(R^{z1}*)₂, wherein R^{z1}* is in each case independently selected from C₁₋₈alkyl, aryl, C₁₋₈heteroaryl, C₃₋₈cycloalkyl, or C₁₋₈heterocyclyl;
R^{z2} is H, F, Cl, Br, I, NO₂, CN, R^{z2}*, OR^{z2}*, SR^{z2}*, N(R^{z2}*)₂, SO₃R^{z2}*, SO₂R^{z2}*, SO₂N(R^{z2}*)₂, C(O)R^{z2}*; C(O)OR^{z2}*, OC(O)R^{z2}*; C(O)N(R^{z2}*)₂, N(R^{z2}*)C(O)R^{z2}*, OC(O)N(R^{z2}*)₂, N(R^{z2}*)C(O)N(R^{z2}*)₂, wherein R^{z2}* is in each case independently selected from C₁₋₈alkyl, aryl, C₁₋₈heteroaryl, C₃₋₈cycloalkyl, or C₁₋₈heterocyclyl;
R^{z3} is H, F, Cl, Br, I, NO₂, CN, R^{z3}*, OR^{z3}*, SR^{z3}*, N(R^{z3}*)₂, SO₃R^{z3}*, SO₂R^{z3}*, SO₂N(R^{z3}*)₂, C(O)R^{z3}*; C(O)OR^{z3}*, OC(O)R^{z3}*; C(O)N(R^{z3}*)₂, N(R^{z3}*)C(O)R^{z3}*, OC(O)N(R^{z3}*)₂, N(R^{z3}*)C(O)N(R^{z3}*)₂, wherein R^{z3}* is in each case independently selected from C₁₋₈alkyl, aryl, C₁₋₈heteroaryl, C₃₋₈cycloalkyl, or C₁₋₈heterocyclyl;
R^{z4} is H, F, Cl, Br, I, NO₂, CN, R^{z4}*, OR^{z4}*, SR^{z4}*, N(R^{z4}*)₂, SO₃R^{z4}*, SO₂R^{z4}*, SO₂N(R^{z4}*)₂, C(O)R^{z4}*; C(O)OR^{z4}*, OC(O)R^{z4}*; C(O)N(R^{z4}*)₂, N(R^{z4}*)C(O)R^{z4}*, OC(O)N(R^{z4}*)₂, N(R^{z4}*)C(O)N(R^{z4}*)₂, wherein R^{z4}* is in each case independently selected from C₁₋₈alkyl, aryl, C₁₋₈heteroaryl, C₃₋₈cycloalkyl, or C₁₋₈heterocyclyl;
   wherein any two or more of R^{z1}, R^{z2}, R^{z3}, and R^{z4} may together form a ring.

In certain embodiments, R^{z2} is aryl or heteroaryl and R^{z4} is aryl or heteroaryl, while R^{z2} and R^{z3} are each hydrogen. In other embodiments, R^{z1} and R^{z2} can together form an aryl or heteroaryl (preferably heteroaryl), and R^{z3} and R^{z4} can together form an aryl or heteroaryl, preferably a heteroaryl. Exemplary heteroaryl systems include:

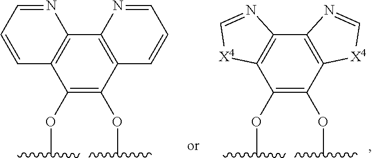

wherein X⁴ is O, S, or NR^{zn}, wherein R^{zn} is C₁₋₄alkyl, optionally substituted by aryl. In certain embodiments of the invention, the compound is not:

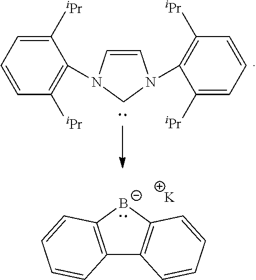

The compounds disclosed herein may be prepared by contacting a compound having the formula:

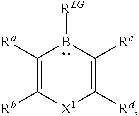

wherein R^{LG} is a leaving group,
with a carbene as defined above to form a mixture, and subsequently reducing the mixture. Exemplary leaving groups include N₂, halides (F, Cl, Br, I), sulfonates such as mesylate (OMs), triflate (OTf), tosylate (OTs), nosylates, and brosylates.

After displacement of the leaving group with the carbene, the resulting product may be reduced to the anionic species. The reduction may be electrochemical, or in the presence of a reductant. In an electrochemical reduction, the starting material is combined with a solvent in contact with an electrode, and an electric current is supplied via the electrode. The skilled person is aware of various chemical reductants and how to use them; special mention may be given to metal-based reductants, for example Li⁰, Na⁰, K⁰, Mg⁰, Zn⁰, and combinations thereof. In addition to bare metals (e.g., metallic lithium, metallic sodium, metallic potassium, metallic magnesium, etc). In other examples, the reductant may be an organometallic reagent, for example, lithium naphthalenide, sodium naphthalenide, potassium graphite, isopropyl magnesium chloride, etc.).

The reduction may be carried out with a molar excess of reductant (whether as supplied electrons in an electrochemical reduction or as a molar excess of reducing reagent). For example, at least two equivalents, at least 3 equivalents, or at least 5 equivalents of reductant may be used. In other embodiments, about two equivalents (2-2.2) may be used.

Subsequent to the reduction, the anionic borole-carbene species may be contacted with a compound having the formula:

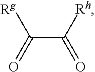

wo provide a compound having the formula:

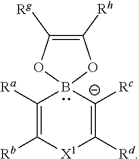

Although the above compound is represented in two-dimensions, the skilled person understands that the tetrasubstituted boron atom is sp³ hybridized and thus adopts a tetrahedral configuration:

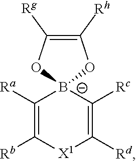

Exemplary compounds of the invention include:

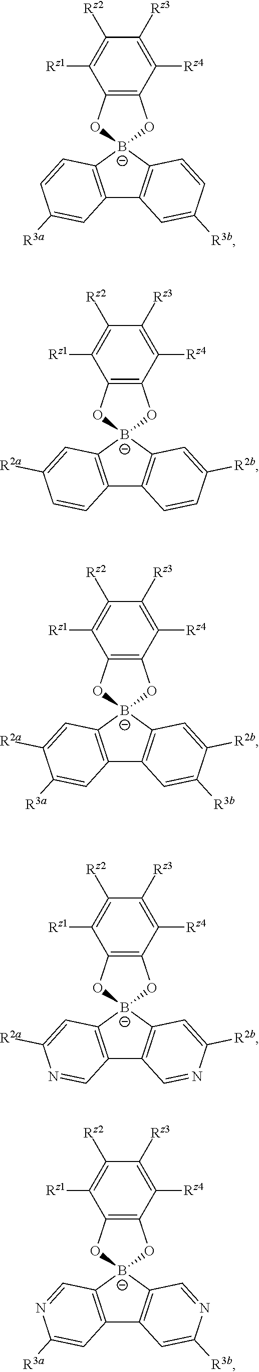

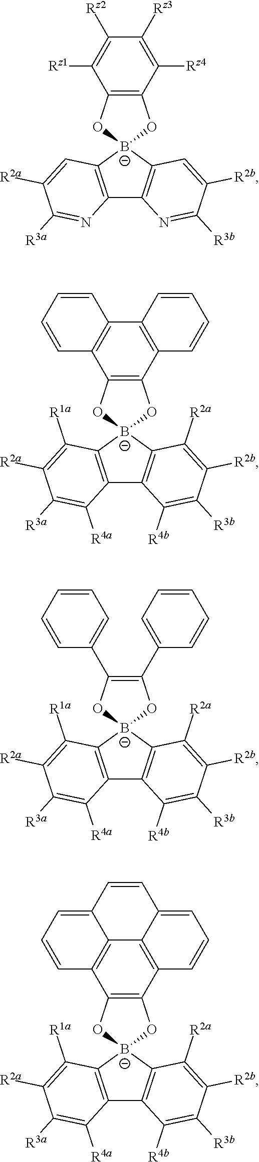

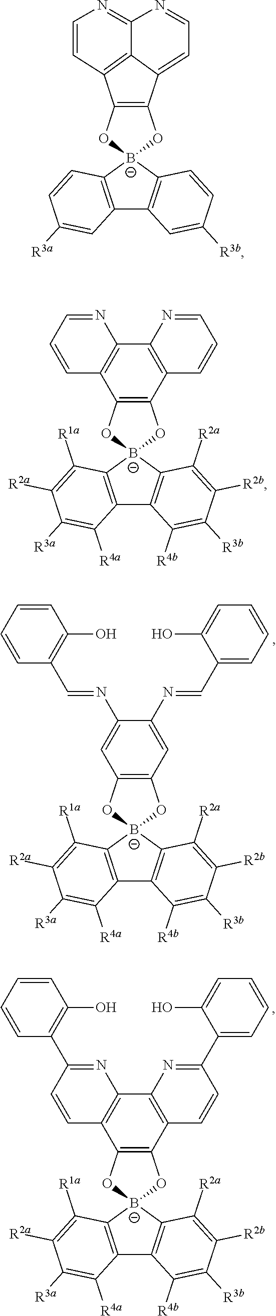

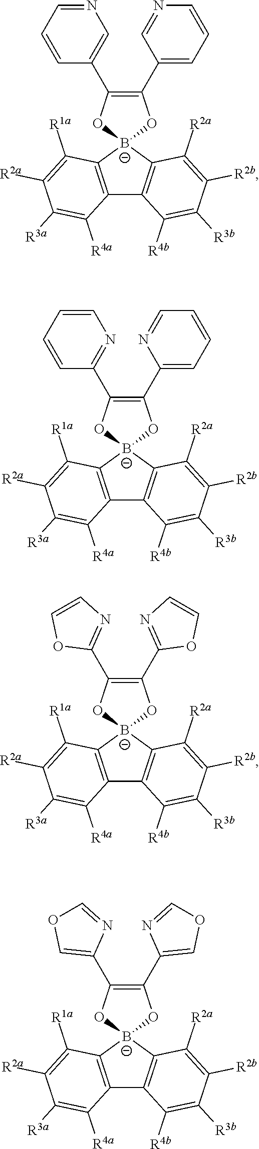

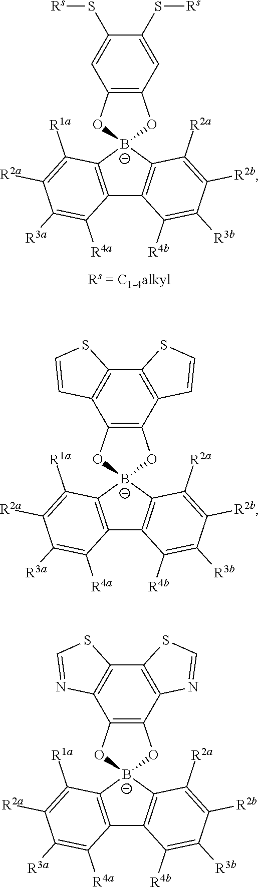

In certain embodiments, the compounds disclosed herein may be used to detect the presence (or absence) of a metal. For example, in some embodiments, the compounds disclosed herein can complex a metal ion, and exhibit differing emissions profiles depending on whether or not the metal complex is present.

The compounds disclosed herein are also useful as bulky, non-nucleophilic bases, and may be advantageously employed as substitutes for conventional bases such as LDA or HMDS. The compounds disclosed herein may be used to deprotonate weakly acidic compounds, for example compounds in which the most acidic proton in the molecule has a pKa no less than 10, no less than 12, no less than 14, no less than 16, no less than 18, no less than 20, no less than 22, no less than 24, no less than 26, no less than 28, no less than 30, no less than 32, no less than 34, or no less than 36.

### EXAMPLES

The following examples are for the purpose of illustration of the invention only and are not intended to limit the scope of the present invention in any manner whatsoever.

All experiments were carried out under an inert atmosphere of argon using an MBRAUN LABmaster glovebox equipped with a −37° C. freezer. The solvents were purified by distillation over sodium and benzophenone. THF-d₈ for NMR experiments was purified by distilled over sodium and stored over Na/K under an inert atmosphere. Glassware was oven-dried at 190° C. overnight. The NMR spectra were recorded at room temperature on a Varian 600 MHz spectrometer. Proton and carbon chemical shifts are reported in ppm and referenced using the residual proton and carbon signals of the deuterated solvent (¹H: THF-d₈−δ=3.58; ¹³C: THF-d₈−δ=67.57), while boron, lithium, and phosphorus chemical shifts are referenced to external standards (¹¹B: BF₃·Et₂O−δ=0.0; ⁷Li: 9.7 M LiCl in D₂O−δ=0.0; ³¹P: 85% H₃PO₄ in H₂O−δ=0.0). Due to the borosilicate NMR probe, a large broad peak is observed at approximately 25 to −25 ppm in the ¹¹B NMR spectra. Triphenylphosphinegold(I) chloride, triethylgermanium chloride, and phenylselenium chloride, were purchased from Strem Chemicals and used as received. Benzil was purchased from Sigma Aldrich and used as received. Compounds 1,¹ and 2² were synthesized according to literature procedures. The UV-visible and fluorescence spectra were recorded on a Cary 60 UV-vis Spectrophotometer and a Cary Eclipse Fluorescence Spectrophotometer. Sample solutions were prepared in THF in 1 cm square air-free quartz cuvettes. Elemental analyses were performed on a Perkin-Elmer 2400 Series II analyzer.

### Example 1: Synthesis of Compounds 1 and 2

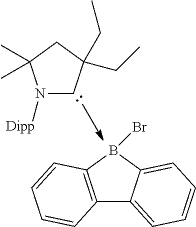

To a solution of EtCAAC (62 mg, 0.20 mmol) in hexane (2.0 mL), 9-bromo-9-borafluorene (48 mg, 0.20 mmol) in hexane (2.0 mL) was added dropwise. The mixture was stirred for 1.5 h, during which time a colorless precipitate formed. The precipitate was collected through filtration and washed with hexane (3×10 mL), and the remaining solid was dried under vacuum to afford product 9 as a white powder (90 mg, 82%). 1 H NMR (600 MHZ, C6D6) δ 7.81 (dd, J=6.2, 1.9 Hz, 2H, ArH), 7.77-7.74 (m, 2H, ArH), 7.32-7.26 (m, 4H, ArH), 7.21-7.18 (m, 1H, ArH), 7.09 (d, J=7.6 Hz, 2H, ArH), 3.06 (hept, J=6.5 Hz, 2H, —CH(CH3)2), 1.85 (d, J=6.6 Hz, 6H, —CH(CH3)2), 1.46 (dt, J=14.9, 7.5 Hz, 2H, —CH2CH3), 1.36 (s, 2H, —CH2-), 1.33 (m, 2H, —CH2CH3), 1.22 (d, J=6.5 Hz, 6H, —CH(CH3)2), 0.85 (s, 6H, —CH3), 0.42 ppm (t, J=7.5 Hz, 6H, —CH2CH3); 13C{1 H} NMR (151 MHz, C6D6) δ 148.3, 145.2, 134.5, 132.4, 129.8, 127.0, 126.4, 125.4, 120.5, 80.1, 63.1 (NC), 41.0 (Cq), 34.0, 29.8, 28.9, 27.8, 25.4, 11.3 ppm; 11B NMR (C6D6, 192 Hz): δ−5.01 ppm (br); Anal. Calcd for C₃₄H₄₃BBrN·C₆H₆·CH₂Cl₂: C, 68.96; H, 7.03; N, 1.91%. Found: C, 68.40; H, 7.20; N, 2.21%.

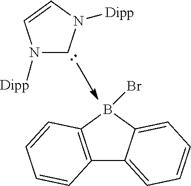

To a solution of IPr (195 mg, 0.50 mmol) in toluene (2.0 mL), 9-bromo-9-borafluorene (122 mg, 0.50 mmol) in toluene (1.0 mL) was added dropwise. The mixture was allowed to stir for 12 h, during which time a colorless precipitate formed. The precipitate was collected through filtration and washed with hexane (3×10 mL), and the remaining solid was dried under vacuum to afford product 1 as a white powder (240 mg, 76%). The NMR data matched with reported.

### Example 2: Synthesis of Compound 3

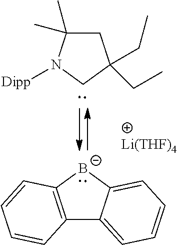

In a 100 mL Schlenk flask, Li metal (24.9 mg, 3.58 mmol) and naphthalene (9.18 mg, 0.0716 mmol) were stirred in THF (40 mL) at room temperature for 40 minutes until a deep green solution was observed. Compound 1 (200 mg, 0.358 mmol) was then added and the reaction immediately became purple in color. The reaction was stirred at room temperature for 18 hrs, during which the solution became deep red in color. The solvent was removed under reduced pressure and the product was extracted with Et₂O (30 mL). The deep red mixture was filtered through a 0.45 μm PTFE syringe filter and the solvent was removed to leave the product as a deep red solid (131 mg, 47% yield). Single crystals were grown from a concentrated solution in Et₂O at −37° C. ¹H NMR (600 MHZ, THF-d₈, 298 K) δ=7.91 (d, 1H, ArH), 7.47 (d, 1H, ArH), 7.34 (d, 1H, ArH), 7.22 (t, 1H, ArH), 7.10 (d, 2H, ArH), 6.67 (t, 1H, ArH), 6.48 (t, 1H, ArH), 6.29 (t, 1H, ArH), 6.00 (t, 1H, ArH), 4.72 (d, 1H, ArH), 3.70 (hept, 2H, CH(CH₃)₂), 2.54 (q, 2H, CH₂CH₃), 2.37 (q, 2H, CH₂CH₃) 2.02 (s, 2H, CH₂), 1.18 (s, 6H, CH₃), 1.17 (d, 6H, CH(CH₃)₂), 1.08 (t, 6H, CH₂CH₃), 0.82 ppm (d, 6H, CH(CH₃)₂); ¹³C{¹H} NMR (151 MHZ, THF-d₈, 298 K) δ=153.9 (ArC), 144.6 (ArC), 144.2 (ArC), 143.8 (ArC), 143.3(ArC), 134.2 (ArC), 133.2 (ArC), 126.7 (ArC), 124.7 (ArC), 121.7 (ArC), 121.0 (ArC), 117.2 (ArC), 116.9 (ArC), 116.3 (ArC), 116.2 (ArC), 68.4 (OCH₂CH₂), 65.5 (OCH₂CH₂), 53.0 (NC), 51.0 (C_{q}), 32.0 (CH(CH₃)₂), 31.6 (CH(CH₃)₂), 29.6 (CH₂CH₃), 27.2 (CH₂CH₃), 26.5 (CH₃), 25.0 (CH₂), 10.9 ppm (CH(CH₃)₂); ¹¹B NMR (193 MHZ, THF-d₈, 298 K) δ=14.45 ppm; ⁷Li NMR (233 MHZ, THF-d₈, 298 K) δ=1.26 ppm.

### Example 3: Synthesis of Compound 4

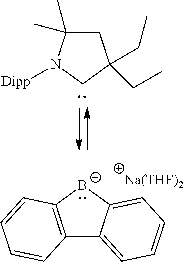

To a solution of compound 1 (200 mg, 0.358 mmol) in THF (40 mL), Na metal (18.1 mg, 0.788 mmol) was added. The reaction was stirred at room temperature for 23 hrs. The deep red solution was filtered through a 0.45 μm PTFE syringe filter, and the solvent was removed under reduced pressure. Red crystals were obtained from a concentrated Et₂O/hexanes (10:1) mixture at room temperature (129 mg, 55% yield). ¹H NMR (600 MHZ, THF-d₈, 298 K) δ=7.91 (d, 1H, ArH), 7.43-7.37 (m, 3H, ArH), 7.09 (td, 2H, ArH), 7.01 (t, 1H, ArH), 6.96 (t, 1H, ArH), 6.92 (m, 2H, ArH), 6.87 (t, 1H, ArH), 4.82 (hept, 1H, CH(CH₃)₂), 4.00 (s, 1H, CH₂), 3.71 (hept, 1H, CH(CH₃)₂), 2.47 (s, 1H, CH₂), 1.62 (d, 3H, CH(CH₃)₂), 1.45 (s, 3H, CH₃), 1.36 (d, 3H, CH(CH₃)₂), 1.29 (dd, 6H, CH(CH₃)₂), 1.09 (q, 2H, CH₂CH₃), 0.86 (s, 3H, CH₃), 0.71 (t, 3H, CH₂CH₃), 0.67 (q, 2H, CH₂CH₃), 0.37 ppm (t, 3H, CH₂CH₃); ¹³C{¹H} NMR (151 MHZ, THF-d₈, 298 K) δ=183.1 (ArC), 179.3 (ArC), 152.6 (ArC), 151.5 (ArC), 149.6 (ArC), 149.1 (ArC), 132.7 (ArC), 132.7 (ArC), 130.9 (ArC), 126.1 (ArC), 126.0 (ArC), 126.0 (ArC), 125.9 (ArC), 124.9 (ArC), 124.7 (ArC), 118.9 (ArC), 118.9 (ArC), 68.4 (OCH₂CH₂), 62.6 (OCH₂CH₂), 50.7 (NC), 49.8 (C_{q}), 47.4 (CH(CH₃)₂), 33.6 (CH(CH₃)₂), 32.7 (CH₂CH₃), 32.2 (CH₂CH₃), 30.1 (CH₂CH₃), 30.0 (CH₂CH₃), 27.9 (CH(CH₃)₂), 27.5 (CH(CH₃)₂), 26.8 (CH₃), 26.6 (CH₃), 25.0 (CH₂), 11.1 (CH(CH₃)₂), 10.3 ppm (CH(CH₃)₂); ¹¹B NMR (193 MHZ, THF-d₈, 298 K) δ=3.51 ppm.

### Example 4: Synthesis of Compound 5

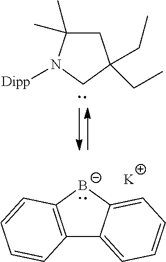

To a solution of compound 1 (1.34 g, 2.40 mmol) in THF (100 mL), KC₈ (0.973 g, 7.20 mmol) was added and the solution immediately turned purple in color. The reaction was stirred at room temperature for 23 hrs. The deep red reaction mixture was filtered over celite to remove graphite, and the solvent was removed from the filtrate under reduced pressure. The crude solid was washed with Et₂O (3×30 mL) to leave the pure product as a red crystalline solid (0.904 g, 73% yield). Single crystals suitable for X-ray crystallography were obtained from the combined and concentrated Et₂O washes at −37° C. ¹H NMR (600 MHZ, THF-d₈, 298 K) δ=8.02 (d, 1H, ArH), 7.66 (d, 2H, ArH), 7.52 (d, 1H, ArH), 7.30 (t, 1H, ArH), 7.17 (d, 2H, ArH), 6.84 (t, 1H, ArH), 6.66 (t, 1H, ArH), 6.45 (t, 1H, ArH), 6.13 (t, 1H, ArH), 4.81 (d, 1H, ArH) 3.59 (hept, 2H, CH(CH₃)₂), 2.52 (m, 2H, CH₂CH₃), 2.41 (m, 2H, CH₂CH₃), 2.07 (s, 2H, CH₂), 1.21 (m, 12H, CH₃/CH(CH₃)₂), 1.11 (m, 6H, CH₂CH₃), 0.81 ppm (d, 6H, CH(CH₃)₂); ¹³C{ ¹H} NMR (151 MHz, THF-d₈, 298 K) δ=183.2 (ArC), 152.6 (ArC), 151.4 (ArC), 149.0 (ArC), 149.0 (ArC), 147.4 (ArC), 133.0 (ArC), 131.4 (ArC), 126.0 (ArC), 125.8 (ArC), 125.8 (ArC), 125.8 (ArC), 124.7 (ArC), 124.7 (ArC), 124.7 (ArC), 119.0 (ArC), 119.0 (ArC), 62.5 (OCH₂CH₂), 50.0 (NC), 47.5 (C_{q}), 33.7 (CH(CH₃)₂), 33.7 (CH(CH₃)₂), 32.7 (CH₂CH₃), 32.7 (CH₂CH₃), 32.3, 30.1 (CH₂CH₃), 30.0 (CH₂CH₃), 27.9 (CH(CH₃)₂), 27.5 (CH(CH₃)₂), 27.1 (CH₃), 26.7 (CH₂), 11.1 (CH(CH₃)₂), 10.3 ppm (CH(CH₃)₂); ¹¹B NMR (193 MHZ, THF-d₈, 298 K) δ=1.46 ppm. Anal. Calcd for C₃₄H₄₃BKN·3/2(Et₂O): C, 75.64; H, 8.87; N, 2.26%. Found: C, 75.27; H, 8.50; N, 2.65%.

### Example 5: Synthesis of Compound 6

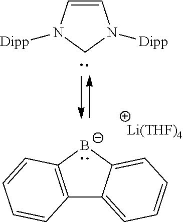

In a 100 mL Schlenk flask, Li metal (6.58 mg, 0.958 mmol) and naphthalene (12.2 mg, 0.0948 mmol) were stirred in THF (40 mL) at room temperature for 20 minutes until a deep green solution was observed. Compound 2 (300 mg, 0.474 mmol) was then added and the reaction immediately became deep blue in color. The reaction was stirred at room temperature for 23 hrs, during which the solution became deep yellow-brown in color. The solvent was removed under reduced pressure and the product was extracted with Et₂O (20 mL). The mixture was filtered through a 0.45 μm PTFE syringe filter, and the solvent was removed to leave the product as a deep brown solid (257 mg, 79% yield). 18-crown-6 (125 mg, 0.474 mmol) was added to a concentrated solution of 6 in Et₂O to yield single crystals suitable for X-ray studies. Dark blue single crystals were grown from a concentrated solution in Et₂O at −37° C. Due to the highly reactive nature of 6 and rapid conversion to the hydridoborafluorene product we relied on X-ray studies for characterization. * Note: For the LiNp reduction of 2, excess reducing agent resulted in NHC ligand activation and a mixture of products were observed from which a molecule showing loss of the N-diisopropylphenyl group on NHC was crystallized and characterized via X-ray crystallography (see Figure S36). Thus, stoichiometric amounts (2 eq.) of LiNp were used for the isolation of 6.

### Example 6: Synthesis of Compound 7

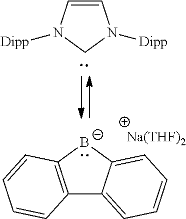

To a solution of compound 2 (200 mg, 0.316 mmol) in THF (40 mL), Na metal (21.8 mg, 0.948 mmol) was added. The reaction was stirred at room temperature for 22 hrs. The solvent was removed under reduced pressure and the product was extracted with Et₂O (40 mL). The deep purple mixture was filtered through a 0.45 μm PTFE syringe filter, and the solvent was removed under reduced pressure. 18-crown-6 ether (83.5 mg, 0.316 mmol) was added to yield single crystals suitable for X-ray studies. Deep purple crystals were obtained from a concentrated Et₂O solution at −37° C.(136 mg, 60% yield).

### Example 7: Synthesis of Compound 8

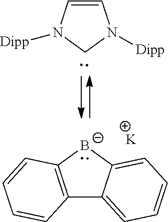

To a solution of compound 2 (2.00 g, 3.16 mmol) in THF (125 mL), KC₈ (1.28 g, 9.48 mmol) was added and the solution immediately turned blue in color. The reaction was stirred at room temperature for 25 hrs. The deep indigo reaction mixture was filtered over celite to remove the graphite and the solvent was removed from the filtrate under reduced pressure. The crude solid was washed with hexanes (3×20 mL) to leave the pure product as a deep indigo solid (1.20 g, 64% yield). Deep purple single crystals were obtained from a concentrated Et₂O solution at −37° C. ¹H NMR (600 MHZ, THF-d₈, 298 K) δ=7.55 (d, 2H, ArH), 7.28 (t, 2H, ArH), 7.21(d, 4H, ArH), 6.43 (s, 2H, ArH), 6.27 (2, 2H, ArH), 6.06 (t, 2H, ArH), 5.91 (d, 2H, ArH), 3.66 (hept, 4H, CH(CH₃)₂), 1.19 (d, 12H, CH(CH₃)₂), 0.97 ppm (d, 12H, CH(CH₃)₂); ¹³C{¹H} NMR (151 MHZ, THF-d₈, 298K) δ=185.1 (ArC), 149.3 (ArC), 141.8 (ArC), 136.6 (ArC), 128.7 (ArC), 128.4 (ArC), 125.0 (ArC), 121.2 (ArC), 119.6 (ArC), 117.8 (ArC), 113.4 (ArC), 29.4 (CH(CH₃)₂), 25.0 (CH(CH₃)₂), 23.4 ppm (CH(CH₃)₂); ¹¹B{¹H} NMR (193 MHZ, THF-d₈, 298 K) δ=7.20 ppm.

### Example 8: Synthesis of Compound 9

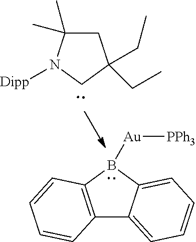

To a solution of compound 5 (100 mg, 0.193 mmol) in THF (25 mL), PPh₃AuCl (95.6 mg, 0.193 mmol) was added. The deep red solution immediately turned orange in color. The reaction was stirred at room temperature for 1.5 hrs, and then the solvent was removed under reduced pressure. The yellow solid product was washed with Et₂O (20 mL), and collected via filtration. The pure product was further dried under reduced pressure to leave compound 9 as a yellow solid (105 mg, 58% yield). Yellow plate-shaped single crystals were grown from a concentrated Et₂O solution at room temperature. ¹H NMR (600 MHZ, THF-d₈, 298 K) δ=8.10 (d, 1H, ArH), 7.61 (d, 1H, ArH), 7.52 (d, 1H, ArH), 7.39 (tq, 3H, ArH), 7.35 (t, 1H ArH), 7.30 (tt, 7H, ArH), 7.25 (m, 6H, ArH), 5.13 (d, 1H, ArH), 3.63 (hept, 1H, CH(CH₃)₂), 3.44 (hept, 1H, CH(CH₃)₂), 2.86 (m, 1H, CH₂CH₃), 2.77 (m, 1H, CH₂CH₃), 2.42 (m, 1H, CH₂CH₃), 2.15 (m, 2H, CH₂CH₃/CH₂), 1.99 (d, 1H, CH₂), 1.65 (s, 3H, CH₃), 1.14 (d, 3H, CH(CH₃)₂), 1.10 (m, 6H, CH(CH₃)₂/CH₂CH₃), 1.04 (d, 3H, CH(CH₃)₂) 0.91 (s, 3H, CH₃), 0.71 (t, 3H, CH₂CH₃), 0.26 ppm (d, 3H, CH(CH₃)₂); ¹³C{¹H} NMR (151 MHZ, THF-d₈, 298K) δ=183.7 (ArC), 152.0 (ArC), 149.2 (ArC), 147.5 (ArC), 146.7 (ArC), 140.2 (ArC), 135.2 (ArC), 135.1 (ArC), 134.7 (ArC), 133.7 (ArC), 132.8 (ArC), 132.5 (ArC), 131.7 (ArC), 131.7 (ArC), 129.8 (ArC), 129.7 (ArC), 128.8 (ArC), 126.3 (ArC), 126.0 (ArC), 124.2 (ArC), 123.2 (ArC), 123.2 (ArC), 123.0 (ArC), 119.1 (ArC), 118.0 (ArC), 69.5 (NC), 56.7 (Ca), 49.8 (CH(CH₃)₂), 39.8 (CH(CH₃)₂), 32.9 (CH₂CH₃), 31.2 (CH₂CH₃), 29.7 (CH₂CH₃), 29.5 (CH₂CH₃), 28.9 (CH₃), 26.1 (CH₃), 25.2 (CH₂), 24.5 (CH(CH₃)₂), 11.5 (CH(CH₃)₂), 11.0 ppm (CH(CH₃)₂); ¹¹B NMR (193 MHZ, THF-d₈, 298 K) δ=3.01 ppm; ³¹P NMR (243 MHZ, THF-d₈, 298 K) δ=39.77 ppm. Anal. Calcd for C₅₆H₆₈AuBNOP: C, 66.74; H, 6.25; N, 1.50%. Found: C, 66.38; H, 6.25; N, 1.66%.

### Example 9: Synthesis of Compound 10

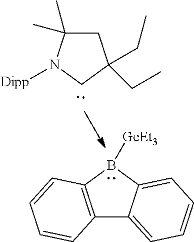

In a Schlenk tube, 5 (50.0 mg, 0.0966 mmol) was dissolved in THF (4 mL), and Et₃GeCl (0.0160 mL, 0.0966 mmol) was added. The reaction was heated to 70° C. for 24 hrs, and then the solvent was removed under reduced pressure. The product was extracted with Et₂O (4 mL) and KCl was removed via 0.45 μm PTFE syringe filter. The filtrate was concentrated under reduced pressure and pink single crystals were obtained at room temperature (25.4 mg, 41% yield). ¹H NMR (600 MHZ, THF-d₈, 298 K) δ=7.50 (d, 2H, ArH), 7.32 (t, 1H, ArH), 7.13 (d, 2H, ArH), 7.04 (d, 2H, ArH), 6.86 (t, 2H, ArH), 6.63 (t, 2H, ArH), 3.09 (b-hept, 2H, CH₂CH₃), 2.69 (hept, 2H, CH₂CH₃), 2.27 (s, 2H, CH₂), 1.90 (hept, 2H, CH(CH₃)₂), 1.38 (s, 6H, CH₃), 1.16 (d, 12H, CH(CH₃)₂/CH₂CH₃), 0.79 (d, 6H, CH(CH₃)₂), 0.47 ppm (br-s, 15H, Ge(CH₂CH₃); ¹³C{¹H} NMR (151 MHz, THF-d₈, 298K) δ=147.6 (ArC), 147.1 (ArC), 137.5 (ArC), 134.5 (ArC), 130.5 (ArC), 126.6 (ArC), 124.5 (ArC), 124.1 (ArC), 118.9 (ArC), 79.3 (NC), 62.8 (C_{q}), 45.6 (CH(CH₃)₂), 33.0 (CH₂CH₃), 30.8 (CH₂CH₃), 29.9 (CH₂CH₃), 26.7 (CH₃), 11.6 (CH(CH₃)₂) 10.5 (GeCH₂CH₃), 10.1 ppm (GeCH₂CH₃); ¹¹B NMR (193 MHZ, THF-d₈, 298 K) δ=−10.75 ppm. Anal. Calcd for C₄₀H₅₈BGeN: C, 75.50; H, 9.19; N, 2.20%. Found: C, 75.75; H, 9.24; N, 2.24%.

### Example 10: Synthesis of Compound 11

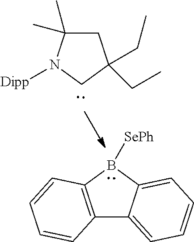

In a 50 mL Schlenk flask, 5 (80.0 mg, 0.155 mmol) was dissolved in THF (10 mL), and then PhSeCl (29.6 mg, 0.155 mmol) was added. The deep red solution immediately turned yellow in color. The reaction was stirred at room temperature for 1 hr. The solvent was removed under reduced pressure and the product was extracted with Et₂O (25 mL). KCl and other insoluble solids were removed via 0.45 μm PTFE syringe filter. The yellow filtrate was concentrated under reduced pressure and colorless single crystals were obtained at room temperature (42.8 mg, 44% yield). ¹H NMR (600 MHZ, THF-d₈, 298 K) δ=7.60 (d, 1H, ArH), 7.54 (d, 1H, ArH), 7.58 (m, 2H, ArH), 7.40 (m, 2H, ArH), 7.34 (d, 1H, ArH), 7.19 (m, 1H, ArH), 7.09 (t, 1H, ArH), 7.02 (d, 1H, ArH), 6.98 (t, 1H, ArH), 6.93 (t, 1H, ArH), 6.85 (t, 1H, ArH), 6.52 (t, 1H, ArH), 6.22 (t, 1H, ArH), 5.98 (t, 1H, ArH), 3.28 (hept, 1H, CH(CH₃)₂), 3.16 (hept, 1H, CH(CH₃)₂), 2.07 (s, 1H, CH₂), 2.05 (d, 3H, CH(CH₃)₂), 2.01 (s, 1H, CH₂), 1.65 (d, 3H, CH(CH₃)₂), 1.47 (m, 10H, CH(CH₃)₂/CH₃/CH₂CH₃), 1.39 (m, 1H, CH₂CH₃), 1.35 (s, 3H, CH₃), 1.27 (m, 1H, CH₂CH₃), 1.19 (m, 1H, CH₂CH₃), 0.63 ppm (m, 6H, CH₂CH₃); ¹³C{ ¹H} NMR (151 MHz, THF-d₈, 298K) δ=149.3 (ArC), 149.0 (ArC), 147.5 (ArC), 145.7 (ArC), 137.8 (ArC), 133.3 (ArC), 132.9 (ArC), 131.3 (ArC), 130.0 (ArC), 127.1 (ArC), 126.6 (ArC), 126.5 (ArC), 126.3 (ArC), 125.7 (ArC), 125.7 (ArC), 124.6 (ArC), 120.1 (ArC), 119.5 (ArC), 81.4 (ArC), 80.9 (ArC), 66.5 (ArC), 64.2 (ArC), 63.4 (NC), 42.2 (C_{q}), 41.4 (CH(CH₃)₂), 34.8 (CH(CH₃)₂), 34.4 (CH₂CH₃), 30.6 (CH₂CH₃), 30.5 (CH₂CH₃), 29.9 (CH₂CH₃), 29.6 (CH₂), 28.9 (CH₃), 28.4 (CH₃), 26.5 (CH(CH₃)₂), 15.9 (CH(CH₃)₂), 11.6 (CH(CH₃)₂), 11.6 ppm (CH(CH₃)₂); ¹¹B NMR (193 MHZ, THF-d₈, 298 K) δ=−5.40 ppm. Anal. Calcd for C₄₀H₄₈NBSe: C, 75.95; H, 7.65; N, 2.21%. Found: C, 75.97; H, 8.09; N, 2.29%.

### Example 11: Synthesis of Compound 12

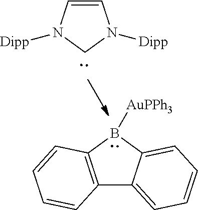

To a solution of compound 8 (50.0 mg, 0.0845 mmol) in THF (4 mL), PPh₃AuCl was then added. The deep purple solution immediately turned green in color. The reaction was then mixed at room temperature for 2 hrs. The insoluble solids were then removed through a 45 μm PTFE syringe filter. The solvent was removed from the filtrate to yield an inseparable mixture of 13 and other unidentifiable products. Single crystals of 13 were obtained from a concentrated Et₂O solution at −37° C. ¹H NMR (600 MHZ, THF-d₈, 298 K) δ=7.37 (m, 4H, ArH), 7.32 (m, 9H, ArH), 7.27 (m, 6H, ArH), 7.12 (d, 4H, ArH), 6.98 (s, 2H, ArH), 6.60 (t, 2H, ArH), 6.22 (t, 2H, ArH), 6.04 (d, 2H, ArH), 3.04 (hept, 4H, CH(CH₃)₂), 1.02 (d, 12H, CH(CH₃)₂), 0.66 ppm (d, 12H, CH(CH₃)₂); ¹³C{¹H} NMR (151 MHZ, THF-d₈, 298K) δ=174.9 (ArC), 135.6 (ArC), 134.8 (ArC), 131.0 (ArC), 130.3 (ArC), 129.4 (ArC), 125.0 (ArC), 124.1 (ArC), 121.8 (ArC), 117.9 (ArC), 30.1 (CH(CH₃)₂), 25.5 (CH(CH₃)₂), 22.9 ppm (CH(CH₃)₂); ¹¹B NMR (193 MHZ, THF-d₈, 298 K) δ=−3.42 ppm; ³¹P NMR (243 MHZ, THF-d₈, 298 K) δ=45.64 ppm.

### Example 12: Synthesis of Compound 13

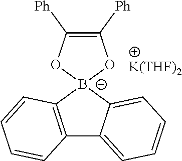

To a solution of compound 5 (80.0 mg, 0.155 mmol) in THF (4 mL), benzil (32.5 mg, 0.155 mmol) was added. The deep red solution immediately turned yellow-green in color, and was stirred at room temperature for 1.5 hrs. The solvent was removed under reduced pressure, and the crude yellow solid was precipitated out of a concentrated toluene/hexanes mixture (2 mL toluene: couple drops of hexanes) at room temperature. Yellow block-shaped single crystals were grown from a toluene/THF (1:1) mixture at room temperature (50.3 mg, 58% yield). Compound 13 can also be obtained following the same procedure, but starting from compound 8 the yield is 44%. ¹H NMR (600 MHZ, THF-d₈, 298 K) δ=7.55 (dt, 4H, ArH), 7.51 (d, 2H, ArH), 7.46 (d, 2H, ArH), 7.11 (t, 4H, ArH), 7.04 (td, 2H, ArH), 6.97 ppm (m, 4H, ArH); ¹³C{¹H} NMR (151 MHZ, THF-d₈, 298K) δ=149.7, 139.4, 138.2, 131.3, 128.4 (ArC), 127.3 (ArC), 127.1 (ArC), 25.6 (ArC), 119.0 (ArC), 68.4 (OCH₂CH₂), 26.6 ppm (OCH₂CH₂); ¹¹B NMR (193 MHZ, THF-d₈, 298 K) δ=13.71 ppm. Anal. Calcd for C₃₄H₃₄BKO₄: C, 73.38; H, 6.16%. Found: C, 73.63; H, 6.04%.

### Example 13: Synthesis of Compound 14

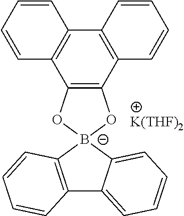

To a solution of 5 (100 mg, 0.193 mmol) in THF (10 mL), 9,10-phenanthrenequionone (40.2 mg, 0.193 mmol) was then added. The deep red solution immediately lost its darkness and turned red in color. The reaction was stirred at room temperature for 5.5 hrs. The solvent was removed under reduced pressure, and the crude solid was washed with Et₂O (10 mL), redissolved in THF (2 mL), and precipitated out with hexanes (5 mL). The pure yellow solid was collected via filtration (58.8 mg, 55% yield). Yellow needle-shaped single crystals were grown from a toluene/THF (1:1) mixture at −37° C. ¹H NMR (600 MHZ, THF-d₈, 298 K) δ=8.66 (d, 2H, ArH), 7.91 (d, 2H, ArH), 7.54 (d, 2H, ArH), 7.33 (m, 6H, ArH), 7.09 (t, 2H, ArH), 6.94 ppm (t, 2H, ArH); ¹³C{¹H} NMR (151 MHZ, THF-d₈, 298K) δ=185.9 (ArC), 149.7 (ArC), 145.3 (ArC), 131.2 (ArC), 127.8 (ArC), 127.3 (ArC), 126.1 (ArC), 126.0 (ArC), 125.7 (ArC), 123.8 (ArC), 121.8 (ArC), 121.0 (ArC), 119.3 (ArC), 68.4 (OCH₂CH₂), 26.5 ppm (OCH₂CH₂); ¹¹B NMR (193 MHz, THF-d₈, 298 K) δ=16.27 ppm. Anal. Calcd for C₂₆H₁₆BKO₂·½(THF): C, 74.02; H, 4.44%. Found: C, 74.21; H, 4.06%.

The compositions and methods of the appended claims are not limited in scope by the specific compositions and methods described herein, which are intended as illustrations of a few aspects of the claims and any compositions and methods that are functionally equivalent are intended to fall within the scope of the claims. Various modifications of the compositions and methods in addition to those shown and described herein are intended to fall within the scope of the appended claims. Further, while only certain representative compositions and method steps disclosed herein are specifically described, other combinations of the compositions and method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated. The term “comprising” and variations thereof as used herein is used synonymously with the term “including” and variations thereof and are open, non-limiting terms. Although the terms “comprising” and “including” have been used herein to describe various embodiments, the terms “consisting essentially of” and “consisting of” can be used in place of “comprising” and “including” to provide for more specific embodiments of the invention and are also disclosed. Other than in the examples, or where otherwise noted, all numbers expressing quantities of ingredients, reaction conditions, and so forth used in the specification and claims are to be understood at the very least, and not as an attempt to limit the application of the doctrine of equivalents to the scope of the claims, to be construed in light of the number of significant digits and ordinary rounding approaches.

1. A compound comprising a borole having the formula: 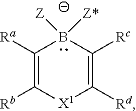
in combination with M⁺, wherein
X¹ is null, O, NRⁿ, or a group having the formula: 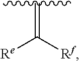
R^{a} is C₁₋₈alkyl, aryl, heteroaryl, or heterocyclyl;
R^{b} is C₁₋₈alkyl, aryl, heteroaryl, or heterocyclyl;
R^{c} is C₁₋₈alkyl, aryl, heteroaryl, or heterocyclyl;
R^{d} is C₁₋₈alkyl, aryl, heteroaryl, or heterocyclyl;
R^{e} is C₁₋₈alkyl, aryl, heteroaryl, or heterocyclyl;
R^{f} is C₁₋₈alkyl, aryl, heteroaryl, or heterocyclyl;
Rⁿ is C₁₋₈alkyl, aryl, heteroaryl, or heterocyclyl;
M⁺ is a cation providing electronic balance;
wherein any two or more of R^{a}, R^{b}, R^{c}, R^{d}, Rⁿ, R^{e}, and R^{f} may together form a ring.
Z is a carbene and Z* is absent, or Z and Z* together form a group having the formula: 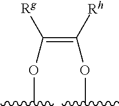
R^{g} is C₁₋₈alkyl, aryl, heteroaryl, or heterocyclyl;
R^{h} is C₁₋₈alkyl, aryl, heteroaryl, or heterocyclyl;
wherein R^{g} and R^{h}, may together form a ring.

2. The compound according to claim 1, wherein the borole has the formula: 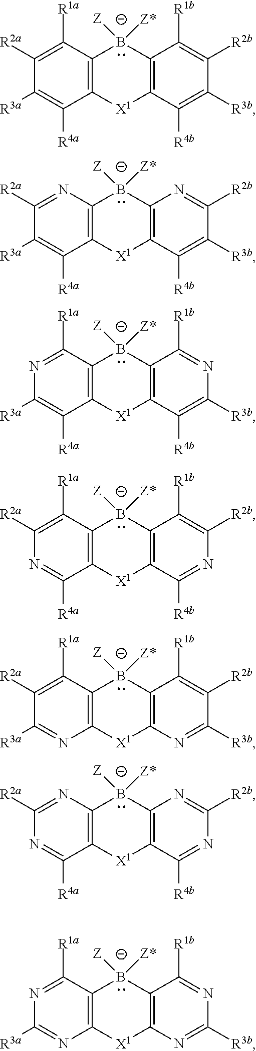
R^{1a} is H, F, Cl, Br, I, NO₂, CN, R^{1a}*, OR^{1a}*, SR^{1a}*, N(R^{1a}*)₂, SO₃R^{1a}*, SO₂R^{1a}*, SO₂N(R^{1a}*)₂, C(O)R^{1a}*; C(O)OR^{1a}*, OC(O)R^{1a}*; C(O)N(R^{1a}*)₂, N(R^{1a}*)C(O)R^{1a}*, OC(O)N(R^{1a}*)₂, N(R^{1a}*)C(O)N(R^{1a}*)₂, wherein R^{1a}* is in each case independently selected from C₁₋₈alkyl, aryl, C₁₋₈heteroaryl, C₃₋₈cycloalkyl, or C₁₋₈heterocyclyl;
R^{2a} is H, F, Cl, Br, I, NO₂, CN, R^{2a}*, OR^{2a}*, SR^{2a}*, N(R^{2a}*,)₂, SO₃R^{2a}*, SO₂R^{2a}*, SO₂N(R^{2a}*,)₂, C(O)R^{2a}*; C(O)OR^{2a}*, OC(O)R^{2a}*; C(O)N(R^{2a}*)₂, N(R^{2a}*)C(O)R^{2a}*, OC(O)N(R^{2a}*)₂, N(R^{2a}*)C(O)N(R^{2a}*,)₂, wherein R^{2a}* is in each case independently selected from C₁₋₈alkyl, aryl, C₁₋₈heteroaryl, C₃₋₈cycloalkyl, or C₁₋₈heterocyclyl;
R^{3a} is H, F, Cl, Br, I, NO₂, CN, R^{3a}*, OR^{3a}*, SR^{3a}*, N(R^{3a}*)₂, SO₃R^{3a}*, SO₂R^{3a}*, SO₂N(R^{3a}*)₂, C(O)R^{3a}*; C(O)OR^{3a}*, OC(O)R^{3a}*; C(O)N(R^{3a}*)₂, N(R^{3a}*)C(O)R^{3a}*, OC(O)N(R^{3a}*)₂, N(R^{3a}*)C(O)N(R^{3a}*)₂, wherein R^{3a}* is in each case independently selected from C₁₋₈alkyl, aryl, C₁₋₈heteroaryl, C₃₋₈cycloalkyl, or C₁₋₈heterocyclyl;
R^{4a} is H, F, Cl, Br, I, NO₂, CN, R^{4a}*, OR^{4a}*, SR^{4a}*, N(R^{4a}*)₂, SO₃R^{4a}*, SO₂R^{4a}*, SO₂N(R^{4a}*)₂, C(O)R^{4a}*; C(O)OR^{4a}*, OC(O)R^{4a}*; C(O)N(R^{4a}*)₂, N(R^{4a}*)C(O)R^{4a}*, OC(O)N(R^{4a}*)₂, N(R^{4a}*)C(O)N(R^{4a}*)₂, wherein R^{4a}* is in each case independently selected from C₁₋₈alkyl, aryl, C₁₋₈heteroaryl, C₃₋₈cycloalkyl, or C₁₋₈heterocyclyl;
wherein any two or more of R^{1a}, R^{2a}, R^{3a}, R^{4a}, Rⁿ, and R^{e} may together form a ring,
R^{1b} is H, F, Cl, Br, I, NO₂, CN, R^{1b}*, OR^{1b}*, SR^{1b}*, N(R^{1b}*)₂, SO₃R^{1b}*, SO₂R^{1b}*, SO₂N(R^{1b}*)₂, C(O)R^{1b}*; C(O)OR^{1b}*, OC(O)R^{1b}*; C(O)N(R^{1b}*)₂, N(R^{1b}*)C(O)R^{1b}*, OC(O)N(R^{1b}*)₂, N(R^{1b}*)C(O)N(R^{1b}*)₂, wherein R^{1b}* is in each case independently selected from C₁₋₈alkyl, aryl, C₁₋₈heteroaryl, C₃₋₈cycloalkyl, or C₁₋₈heterocyclyl;
R^{2b} is H, F, Cl, Br, I, NO₂, CN, R^{2b}*, OR^{2b}*, SR^{2b}*, N(R^{2b}*)₂, SO₃R^{2b}*, SO₂R^{2b}*, SO₂N(R^{2b}*)₂, C(O)R^{2b}*; C(O)OR^{2b}*, OC(O)R^{2b}*; C(O)N(R^{2b}*)₂, N(R^{2b}*)C(O)R^{2b}*, OC(O)N(R^{2b}*)₂, N(R^{2b}*)C(O)N(R^{2b}*)₂, wherein R^{2b}* is in each case independently selected from C₁₋₈alkyl, aryl, C₁₋₈heteroaryl, C₃₋₈cycloalkyl, or C₁₋₈heterocyclyl;
R^{3b} is H, F, Cl, Br, I, NO₂, CN, R^{3b}*, OR^{3b}*, SR^{3b}*, N(R^{3b}*)₂, SO₃R^{3b}*, SO₂R^{3b}*, SO₂N(R^{3b}*)₂, C(O)R^{3b}*; C(O)OR^{3b}*, OC(O)R^{3b}*; C(O)N(R^{3b}*)₂, N(R^{3b}*)C(O)R^{3b}*, OC(O)N(R^{3b}*)₂, N(R^{3b}*)C(O)N(R^{3b}*)₂, wherein R^{3b}* is in each case independently selected from C₁₋₈alkyl, aryl, C₁₋₈heteroaryl, C₃₋₈cycloalkyl, or C₁₋₈heterocyclyl;
R^{4b} is H, F, Cl, Br, I, NO₂, CN, R^{4b}*, OR^{4b}*, SR^{4b}*, N(R^{4b}*)₂, SO₃R^{4b}*, SO₂R^{4b}*, SO₂N(R^{4b}*)₂, C(O)R^{4b}*; C(O)OR^{4b}*, OC(O)R^{4b}*; C(O)N(R^{4b}*)₂, N(R^{4b}*)C(O)R^{4b}*, OC(O)N(R^{4b}*)₂, N(R^{4b}*)C(O)N(R^{4b}*)₂, wherein R^{4b}* is in each case independently selected from C₁₋₈alkyl, aryl, C₁₋₈heteroaryl, C₃₋₈cycloalkyl, or C₁₋₈heterocyclyl;
wherein any two or more of R^{1b}, R^{2b}, R^{3b}, R^{4b}, Rⁿ, and R^{f} may together form a ring,

3. The compound according to claim 1, wherein the borole has the formula:

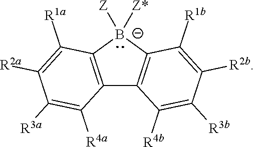

4. The compound according to claim 1, wherein X¹ is null.

5. The compound according to claim 1, wherein X¹ is O.

6. The compound according to claim 1, wherein X¹ is NRⁿ.

7. The compound according to claim 1, wherein X¹ is:

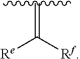

8. The compound according to claim 1, wherein R^{1a}, R^{2a}, and R^{3a} are each hydrogen.

9-23. (canceled)

24. The compound according to claim 1 wherein Z and Z* form a diaminocarbene or a heteroamino carbene.

25. The compound according to claim 24, wherein Z and Z* form a carbene having the formula: 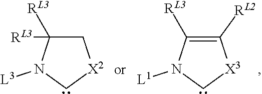
X² is O, S, or C(R^{L4})₂
X³ is NL², O, or S;
L¹ is C₁₋₂₀alkyl, aryl or heteroaryl,
L² is C₁₋₂₀alkyl, aryl or heteroaryl,
R^{L1} is hydrogen, C₁₋₁₂alkyl, cycloalkyl, aryl, heteroaryl;
R^{L2} is hydrogen, C₁₋₁₂alkyl, cycloalkyl, aryl, heteroaryl;
R^{L3} is in each case independently selected from C₁₋₂₀alkyl, aryl, heteroaryl; wherein two R^{L3} groups may together form a ring;
R^{L4} is in each case independently selected from C₁₋₂₀alkyl, aryl, heteroaryl; wherein two R^{L4} groups may together form a ring;
wherein L¹ and R^{L1} may together form a ring;
wherein R^{L1} and R^{L2} may together form a ring;
wherein L² and R^{L2} may together form a ring;
wherein L³ and one or both of R^{L3} may together form a ring.

26-29. (canceled)

30. The compound according to claim 24, wherein Z and Z* form a carbene having the formula: 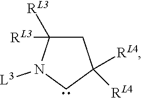
wherein L³ is selected from aryl and C₁₋₈alkyl.

31-34. (canceled)

35. The compound according to claim 1, wherein Z and Z* together form a ring having the formula: 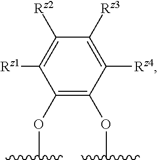
R^{z1} is H, F, Cl, Br, I, NO₂, CN, R^{z1}*, OR^{z1}*, SR^{z1}*, N(R^{z1}*)₂, SO₃R^{z1}*, SO₂R^{z1}*, SO₂N(R^{z1}*)₂, C(O)R^{z1}*; C(O)OR^{z1}*, OC(O)R^{z1 *;} C(O)N(R^{z1}*)₂, N(R^{z1}*)C(O)R^{z1}*, OC(O)N(R^{z1}*)₂, N(R^{z1}*)C(O)N(R^{z1}*)₂, wherein R^{z1}* is in each case independently selected from C₁₋₈alkyl, aryl, C₁₋₈heteroaryl, C₃₋₈cycloalkyl, or C₁₋₈heterocyclyl;
R^{z2} is H, F, Cl, Br, I, NO₂, CN, R^{z2}*, OR^{z2}*, SR^{z2}*, N(R^{z2}*)₂, SO₃R^{z2}*, SO₂R^{z2}*, SO₂N(R^{z2}*)₂, C(O)R^{z2}*; C(O)OR^{z2}*, OC(O)R^{z2}*; C(O)N(R^{z2}*)₂, N(R^{z2}*)C(O)R^{z2}*, OC(O)N(R^{z2}*)₂, N(R^{z2}*)C(O)N(R^{z2}*)₂, wherein R^{z2}* is in each case independently selected from C₁₋₈alkyl, aryl, C₁₋₈heteroaryl, C₃₋₈cycloalkyl, or C₁₋₈heterocyclyl;
R^{z3} is H, F, Cl, Br, I, NO₂, CN, R^{z3}*, OR^{z3}*, SR^{z3}*, N(R^{z3}*)₂, SO₃R^{z3}*, SO₂R^{z3}*, SO₂N(R^{z3}*)₂, C(O)R^{z3}*; C(O)OR^{z3}*, OC(O)R^{z3}*; C(O)N(R^{z3}*)₂, N(R^{z3}*)C(O)R^{z3}*, OC(O)N(R^{z3}*)₂, N(R^{z3}*)C(O)N(R^{z3}*)₂, wherein R^{z3}* is in each case independently selected from C₁₋₈alkyl, aryl, C₁₋₈heteroaryl, C₃₋₈cycloalkyl, or C₁₋₈heterocyclyl;
R^{z4} is H, F, Cl, Br, I, NO₂, CN, R^{z4}*, OR^{z4}*, SR^{z4}*, N(R^{z4}*)₂, SO₃R^{z4}*, SO₂R^{2a}*, SO₂N(R^{z4}*)₂, C(O)R^{z4}*; C(O)OR^{z4}*, OC(O)R^{z4}*; C(O)N(R^{z4}*)₂, N(R^{z4}*)C(O)R^{z4}*, OC(O)N(R^{z4}*)₂, N(R^{z4}*)C(O)N(R^{z4}*)₂, wherein R^{z4}* is in each case independently selected from C₁₋₈alkyl, aryl, C₁₋₈heteroaryl, C₃₋₈cycloalkyl, or C₁₋₈heterocyclyl;
wherein any two or more of R^{z1}, R^{z2}, R^{z3}, and R^{z4} may together form a ring.

36-37. (canceled)

38. The compound according to claim 1, wherein Z and Z* together form a ring having the formula: 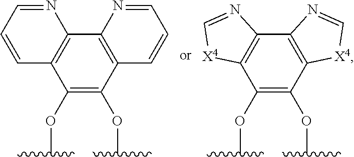
wherein X⁴ is O, S, or NR^{zn}, wherein R^{zn} is C₁₋₄alkyl, optionally substituted by aryl.

39. The compound according to claim 1, wherein M⁺ comprises an alkali cation, an alkaline earth metal, or tetraalkylammonium, a crown ether, aza-crown ether, thia-crown ether, cryptand, bis-chelating ligand, tri-chelating ligand, or a combination thereof.

40-43. (canceled)

44. The compound according to claim 1, wherein the compound is not:

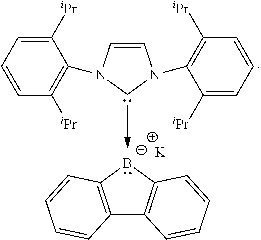

45. A method for making the compound according to claim 1, comprising:
contacting a compound having the formula: 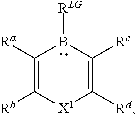
wherein R^{LG} is a leaving group,
with a carbene to form a mixture, and reducing the mixture.

46-52. (canceled)

53. A method for detecting the presence or absence of a metal, comprising irradiating the compound according to claim 1 and detecting the resulting emission.

54. A method of deprotonating a compound, comprising contacting a compound having at least one acidic proton with the compound according to claim 1.

55. (canceled)
